(19) United States
(12) Patent Application Publication
(10) Pub. No.: US 2022/0114126 A1
(43) Pub. Date: Apr. 14, 2022

(54) TECHNOLOGIES FOR A CONTROLLER HUB WITH A USB CAMERA

(71) Applicant: Intel Corporation, Santa Clara, CA (US)

(72) Inventors: Aruni P. Nelson, Rocklin, CA (US); Ashok Mishra, Portland, OR (US); John S. Howard, Portland, OR (US)

(73) Assignee: Intel Corporation, Santa Clara, CA (US)

(21) Appl. No.: 17/556,159

(22) Filed: Dec. 20, 2021

(51) Int. Cl. G06F 13/40; G06F 13/38; G06F 13/42

(52) U.S. Cl. CPC G06F 13/4068; G06F 2213/40; G06F 13/4282; G06F 13/382

(57) ABSTRACT

Techniques for interfacing with a universal serial bus (USB) camera by a controller hub are disclosed. In one embodiment, a controller hub includes a USB multiplexer, allowing the USB camera connected to the multiplexer to be controlled by a component of the controller hub or by a host controller of a host system. In another embodiment, a USB camera is connected to a controller hub, and the controller hub includes USB video class (UVC) function circuitry to send images from the USB camera to a host controller of a host system. The images can also be processed by a component of the controller hub.

### BACKGROUND

Existing laptops comprise various input sensors in the lid, such as microphones, cameras, and a touchscreen. The sensor data generated by these lid sensors are delivered by wires that travel across a hinge to the base of the laptop where they are processed by the laptop's computing resources and made accessible to the operating system and applications.

### BRIEF DESCRIPTION OF THE DRAWINGS

FIG. 1A is a block diagram of a first example computing device comprising a lid controller hub.

FIG. 1B is a perspective view of a second example mobile computing device in which a lid controller hub can be utilized.

FIG. 2 is a block diagram of a third example mobile computing device comprising a lid controller hub.

FIG. 3 is a block diagram of a fourth example mobile computing device comprising a lid controller hub.

FIG. 4 is a block diagram of the security module of the lid controller hub of FIG. 3.

FIG. 5 is a block diagram of the host module of the lid controller hub of FIG. 3

FIG. 6 is a block diagram of the vision-imaging module of the lid controller hub of FIG. 3

FIG. 7 is a block diagram of the audio module of the lid controller hub of FIG. 3.

FIG. 8 is a block diagram of the timing controller, embedded display, and additional electronics used in conjunction with the lid controller hub of FIG. 3

FIG. 9 is a block diagram illustrating an example physical arrangement of components in a mobile computing device comprising a lid controller hub.

FIGS. 10A-10E are block diagrams of example timing controller and lid controller hub physical arrangements within a lid.

FIG. 11 is a simplified block diagram of at least one embodiment of a computing device with a Universal Serial Bus (USB) camera.

FIG. 12 is a simplified block diagram of at least one embodiment of an environment that may be established by the computing device of FIG. 11.

FIG. 13 is a simplified block diagram of a communication path between components of one embodiment of the computing device of FIG. 11.

FIG. 14 is a simplified block diagram of at least one embodiment of an environment that may be established by the computing device of FIG. 11.

FIG. 15 is a simplified block diagram of a communication path between components of one embodiment of the computing device of FIG. 11.

FIGS. 16-19 are a simplified flow diagram of at least one embodiment of a method for controlling a USB camera that may be executed by the computing device of FIG. 11.

FIGS. 20-22 are a simplified flow diagram of at least one embodiment of a method for controlling a USB camera that may be executed by the computing device of FIG. 11.

### DETAILED DESCRIPTION

Lid controller hubs are disclosed herein that perform a variety of computing tasks in the lid of a laptop or computing devices with a similar form factor. A lid controller hub can process sensor data generated by microphones, a touchscreen, cameras, and other sensors located in a lid. A lid controller hub allows for laptops with improved and expanded user experiences, increased privacy and security, lower power consumption, and improved industrial design over existing devices. For example, a lid controller hub allows the sampling and processing of touch sensor data to be synchronized with a display's refresh rate, which can result in a smooth and responsive touch experience across. The continual monitoring and processing of image and audio sensor data captured by cameras and microphones located in the lid allow a laptop to wake when an authorized user's voice and face is detected. The lid controller hub provides enhanced safety by operating in a trusted execution environment. Only properly authenticated firmware is allowed to operate in the lid controller hub, meaning that no unwanted applications can access lid-based microphones and cameras.

Enhanced and improved experiences are enabled by the lid controller hub's computing resources. For example, neural network accelerators within the lid controller hub can blur displays or faces in the background of a video call or filter out the sound of a dog barking in the background of an audio call. Power savings are realized through the use of various techniques such as enabling sensors when they are likely to be in use, such as sampling touch input at a display at a typical sampling rates when touch interaction is detected. Processing sensor data locally in the lid instead of having to send it across the hinge and then have it processed by the operating system, provides for latency improvements and saves power. Lid controller hub also allows for laptop designs in which fewer wires are carried across a hinge. Not only can this reduce hinge cost, it can result in a simpler and thus more aesthetically pleasing industrial design. These and other lid controller hub features and advantages are discussed in greater detail below.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

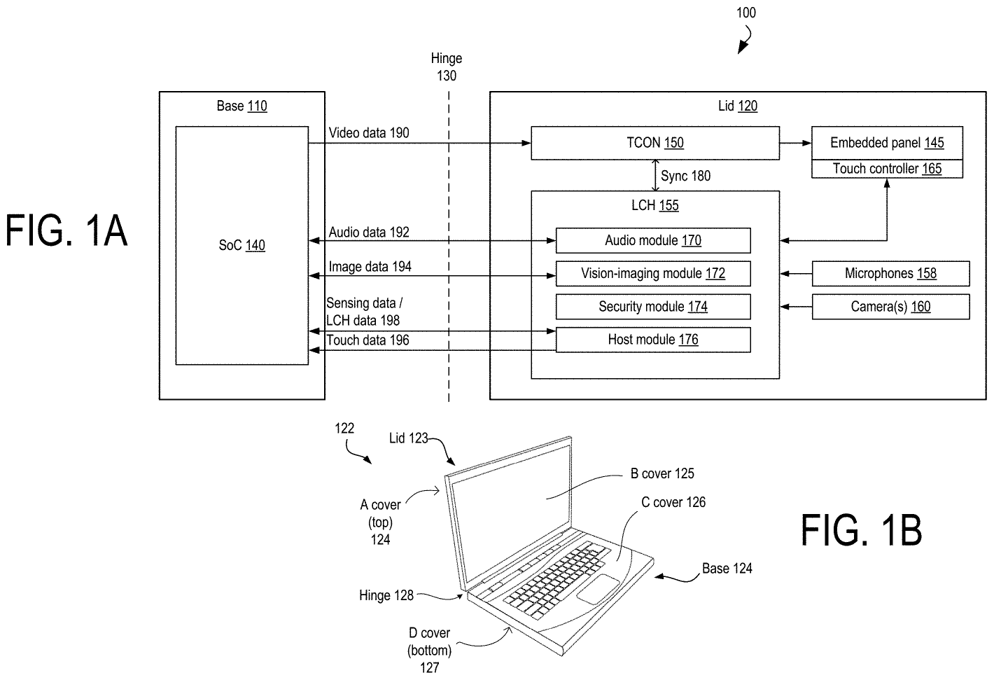

FIG. 1A illustrates a block diagram of a first example mobile computing device comprising a lid controller hub. The computing device 100 comprises a base 110 connected to a lid 120 by a hinge 130. The mobile computing device (also referred to herein as “user device”) 100 can be a laptop or a mobile computing device with a similar form factor. The base 110 comprises a host system-on-a-chip (SoC) 140 that comprises one or more processor units integrated with one or more additional components, such as a memory controller, graphics processing unit (GPU), caches, an image processing module, and other components described herein. The base 110 can further comprise a physical keyboard, touchpad, battery, memory, storage, and external ports. The lid 120 comprises an embedded display panel 145, a timing controller (TCON) 150, a lid controller hub (LCH) 155, microphones 158, one or more cameras 160, and a touch controller 165. TCON 150 converts video data 190 received from the SoC 140 into signals that drive the display panel 145.

The display panel 145 can be any type of embedded display in which the display elements responsible for generating light or allowing the transmission of light are located in each pixel. Such displays may include TFT LCD (thin-film-transistor liquid crystal display), micro-LED (micro-light-emitting diode (LED)), OLED (organic LED), and QLED (quantum dot LED) displays. A touch controller 165 drives the touchscreen technology utilized in the display panel 145 and collects touch sensor data provided by the employed touchscreen technology. The display panel 145 can comprise a touchscreen comprising one or more dedicated layers for implementing touch capabilities or ‘in-cell’ or ‘on-cell’ touchscreen technologies that do not require dedicated touchscreen layers.

The microphones 158 can comprise microphones located in the bezel of the lid or in-display microphones located in the display area, the region of the panel that displays content. The one or more cameras 160 can similarly comprise cameras located in the bezel or in-display cameras located in the display area.

LCH 155 comprises an audio module 170, a vision/imaging module 172, a security module 174, and a host module 176. The audio module 170, the vision/imaging module 172 and the host module 176 interact with lid sensors and process the sensor data generated by the sensors. The audio module 170 interacts with the microphones 158 and processes audio sensor data generated by the microphones 158, the vision/imaging module 172 interacts with the one or more cameras 160 and processes image sensor data generated by the one or more cameras 160, and the host module 176 interacts with the touch controller 165 and processes touch sensor data generated by the touch controller 165. A synchronization signal 180 is shared between the timing controller 150 and the lid controller hub 155. The synchronization signal 180 can be used to synchronize the sampling of touch sensor data and the delivery of touch sensor data to the SoC 140 with the refresh rate of the display panel 145 to allow for a smooth and responsive touch experience at the system level.

As used herein, the phrase “sensor data” can refer to sensor data generated or provided by sensor as well as sensor data that has undergone subsequent processing. For example, image sensor data can refer to sensor data received at a frame router in a vision/imaging module as well as processed sensor data output by a frame router processing stack in a vision/imaging module. The phrase “sensor data” can also refer to discrete sensor data (e.g., one or more images captured by a camera) or a stream of sensor data (e.g., a video stream generated by a camera, an audio stream generated by a microphone). The phrase “sensor data” can further refer to metadata generated from the sensor data, such as a gesture determined from touch sensor data or a head orientation or facial landmark information generated from image sensor data.

The audio module 170 processes audio sensor data generated by the microphones 158 and in some embodiments enables features such as Wake on Voice (causing the device 100 to exit from a low-power state when a voice is detected in audio sensor data), Speaker ID (causing the device 100 to exit from a low-power state when an authenticated user's voice is detected in audio sensor data), acoustic context awareness (e.g., filtering undesirable background noises), speech and voice pre-processing to condition audio sensor data for further processing by neural network accelerators, dynamic noise reduction, and audio-based adaptive thermal solutions.

The vision/imaging module 172 processes image sensor data generated by the one or more cameras 160 and in various embodiments can enable features such as Wake on Face (causing the device 100 to exit from a low-power state when a face is detected in image sensor data) and Face ID (causing the device 100 to exit from a low-power state when an authenticated user's face is detected in image sensor data). In some embodiments, the vision/imaging module 172 can enable one or more of the following features: head orientation detection, determining the location of facial landmarks (e.g., eyes, mouth, nose, eyebrows, cheek) in an image, and multi-face detection.

The host module 176 processes touch sensor data provided by the touch controller 165. The host module 176 is able to synchronize touch-related actions with the refresh rate of the embedded panel 145. This allows for the synchronization of touch and display activities at the system level, which provides for an improved touch experience for any application operating on the mobile computing device.

Thus, the LCH 155 can be considered to be a companion die to the SoC 140 in that the LCH 155 handles some sensor data-related processing tasks that are performed by SoCs in existing mobile computing devices. The proximity of the LCH 155 to the lid sensors allows for experiences and capabilities that may not be possible if sensor data has to be sent across the hinge 130 for processing by the SoC 140. The proximity of LCH 155 to the lid sensors reduces latency, which creates more time for sensor data processing. For example, as will be discussed in greater detail below, the LCH 155 comprises neural network accelerators, digital signals processors, and image and audio sensor data processing modules to enable features such as Wake on Voice, Wake on Face, and contextual understanding. Locating LCH computing resources in proximity to lid sensors also allows for power savings as lid sensor data needs to travel a shorter length—to the LCH instead of across the hinge to the base.

Lid controller hubs allow for additional power savings. For example, an LCH allows the SoC and other components in the base to enter into a low-power state while the LCH monitors incoming sensor data to determine whether the device is to transition to an active state. By being able to wake the device only when the presence of an authenticated user is detected (e.g., via Speaker ID or Face ID), the device can be kept in a low-power state longer than if the device were to wake in response to detecting the presence of any person. Lid controller hubs also allow the sampling of touch inputs at an embedded display panel to be reduced to a lower rate (or be disabled) in certain contexts. Additional power savings enabled by a lid controller hub are discussed in greater detail below.

As used herein the term “active state” when referencing a system-level state of a mobile computing device refers to a state in which the device is fully usable. That is, the full capabilities of the host processor unit and the lid controller hub are available, one or more applications can be executing, and the device is able to provide an interactive and responsive user experience—a user can be watching a movie, participating in a video call, surfing the web, operating a computer-aided design tool, or using the device in one of a myriad of other fashions. While the device is in an active state, one or more modules or other components of the device, including the lid controller hub or constituent modules or other components of the lid controller hub, can be placed in a low-power state to conserve power. The host processor units can be temporarily placed in a high-performance mode while the device is in an active state to accommodate demanding workloads. Thus, a mobile computing device can operate within a range of power levels when in an active state.

As used herein, the term “low-power state” when referencing a system-level state of a mobile computing device refers to a state in which the device is operating at a lower power consumption level than when the device is operating in an active state. Typically, the host processing unit is operating at a lower power consumption level than when the device is in an active state and more device modules or other components are collectively operating in a low-power state than when the device is in an active state. A device can operate in one or more low-power states with one difference between the low-power states being characterized by the power consumption level of the device level. In some embodiments, another difference between low-power states is characterized by how long it takes for the device to wake in response to user input (e.g., keyboard, mouse, touch, voice, user presence being detected in image sensor data, a user opening or moving the device), a network event, or input from an attached device (e.g., USB device). Such low-power states can be characterized as “standby”, “idle”, “sleep” or “hibernation” states.

In a first type of device-level low-power state, such as ones characterized as an “idle” or “standby” low-power state, the device can quickly transition from the low-power state to an active state in response to user input, hardware or network events. In a second type of device-level low-power state, such as one characterized as a “sleep” state, the device consumes less power than in the first type of low-power state and volatile memory is kept refreshed to maintain the device state. In a third type of device-level low-power state, such as one characterized as a “hibernate” low-power state, the device consumes less power than in the second type of low-power state. Non-volatile memory is not kept refreshed and the device state is stored in non-volatile memory. The device takes a longer time to wake from the third type of low-power state than from a first or second type of low-power state due to having to restore the system state from non-volatile memory. In a fourth type of low-power state, the device is off and not consuming power. Waking the device from an off state requires the device to undergo a full reboot. As used herein, waking a device refers to a device transitioning from a low-power state to an active state.

In reference to a lid controller hub, the term “active state”, refers to a lid controller hub state in which the full resources of the lid controller hub are available. That is, the LCH can be processing sensor data as it is generated, passing along sensor data and any data generated by the LCH based on the sensor data to the host SoC, and displaying images based on video data received from the host SoC. One or more components of the LCH can individually be placed in a low-power state when the LCH is in an active state. For example, if the LCH detects that an authorized user is not detected in image sensor data, the LCH can cause a lid display to be disabled. In another example, if a privacy mode is enabled, LCH components that transmit sensor data to the host SoC can be disabled. The term “low-power” state, when referring to a lid controller hub can refer to a power state in which the LCH operates at a lower power consumption level than when in an active state, and is typically characterized by one or more LCH modules or other components being placed in a low-power state than when the LCH is in an active state. For example, when the lid of a computing device is closed, a lid display can be disabled, an LCH vision/imaging module can be placed in a low-power state and an LCH audio module can be kept operating to support a Wake on Voice feature to allow the device to continue to respond to audio queries.

A module or any other component of a mobile computing device can be placed in a low-power state in various manners, such as by having its operating voltage reduced, being supplied with a clock signal with a reduced frequency, or being placed into a low-power state through the receipt of control signals that cause the component to consume less power (such as placing a module in an image display pipeline into a low-power state in which it performs image processing on only a portion of an image).

In some embodiments, the power savings enabled by an LCH allow for a mobile computing device to be operated for a day under typical use conditions without having to be recharged. Being able to power a single day's use with a lower amount of power can also allow for a smaller battery to be used in a mobile computing device. By enabling a smaller battery as well as enabling a reduced number of wires across a hinge connecting a device to a lid, laptops comprising an LCH can be thinner and lighter and thus have an improved industrial design over existing devices.

In some embodiments, the lid controller hub technologies disclosed herein allow for laptops with intelligent collaboration and personal assistant capabilities. For example, an LCH can provide near-field and far-field audio capabilities that allow for enhanced audio reception by detecting the location of a remote audio source and improving the detection of audio arriving from the remote audio source location. When combined with Wake on Voice and Speaker ID capabilities, near- and far-field audio capabilities allow for a mobile computing device to behave similarly to the “smart speakers” that are pervasive in the market today. For example, consider a scenario where a user takes a break from working, walks away from their laptop, and asks the laptop from across the room, “What does tomorrow's weather look like?” The laptop, having transitioned into a low-power state due to not detecting the face of an authorized user in image sensor data provided by a user-facing camera, is continually monitoring incoming audio sensor data and detects speech coming from an authorized user. The laptop exits its low-power state, retrieves the requested information, and answers the user's query.

The hinge 130 can be any physical hinge that allows the base 110 and the lid 120 to be rotatably connected. The wires that pass across the hinge 130 comprise wires for passing video data 190 from the SoC 140 to the TCON 150, wires for passing audio data 192 between the SoC 140 and the audio module 170, wires for providing image data 194 from the vision/imaging module 172 to the SoC 140, wires for providing touch data 196 from the LCH 155 to the SoC 140, and wires for providing data determined from image sensor data and other information generated by the LCH 155 from the host module 176 to the SoC 140. In some embodiments, data shown as being passed over different sets of wires between the SoC and LCH are communicated over the same set of wires. For example, in some embodiments, touch data, sensing data, and other information generated by the LCH can be sent over a single USB bus.

In some embodiments, the lid 120 is removably attachable to the base 110. In some embodiments, the hinge can allow the base 110 and the lid 120 to rotate to substantially 360 degrees with respect to either other. In some embodiments, the hinge 130 carries fewer wires to communicatively couple the lid 120 to the base 110 relative to existing computing devices that do not have an LCH. This reduction in wires across the hinge 130 can result in lower device cost, not just due to the reduction in wires, but also due to being a simpler electromagnetic and radio frequency interface (EMI/RFI) solution.

The components illustrated in FIG. 1A as being located in the base of a mobile computing device can be located in a base housing and components illustrated in FIG. 1A as being located in the lid of a mobile computing device can be located in a lid housing.

FIG. 1B illustrates a perspective view of a secondary example mobile computing comprising a lid controller hub. The mobile computing device 122 can be a laptop or other mobile computing device with a similar form factor, such as a foldable tablet or smartphone. The lid 123 comprises an “A cover” 124 that is the world-facing surface of the lid 123 when the mobile computing device 122 is in a closed configuration and a “B cover” 125 that comprises a user-facing display when the lid 123 is open. The base 129 comprises a “C cover” 126 that comprises a keyboard that is upward facing when the device 122 is an open configuration and a “D cover” 127 that is the bottom of the base 129. In some embodiments, the base 129 comprises the primary computing resources (e.g., host processor unit(s), GPU) of the device 122, along with a battery, memory, and storage, and communicates with the lid 123 via wires that pass through a hinge 128. Thus, in embodiments where the mobile computing device is a dual-display device, such as a dual display laptop, tablet, or smartphone, the base can be regarded as the device portion comprising host processor units and the lid can be regarded as the device portion comprising an LCH. A Wi-Fi antenna can be located in the base or the lid of any computing device described herein.

In other embodiments, the computing device 122 can be a dual display device with a second display comprising a portion of the C cover 126. For example, in some embodiments, an “always-on” display (AOD) can occupy a region of the C cover below the keyboard that is visible when the lid 123 is closed. In other embodiments, a second display covers most of the surface of the C cover and a removable keyboard can be placed over the second display or the second display can present a virtual keyboard to allow for keyboard input.

Lid controller hubs are not limited to being implemented in laptops and other mobile computing devices having a form factor similar to that illustrated FIG. 1B. The lid controller hub technologies disclosed herein can be employed in mobile computing devices comprising one or more portions beyond a base and a single lid, the additional one or more portions comprising a display and/or one or more sensors. For example, a mobile computing device comprising an LCH can comprise a base; a primary display portion comprising a first touch display, a camera, and microphones; and a secondary display portion comprising a second touch display. A first hinge rotatably couples the base to the secondary display portion and a second hinge rotatably couples the primary display portion to the secondary display portion. An LCH located in either display portion can process sensor data generated by lid sensors located in the same display portion that the LCH is located in or by lid sensors generated in both display portions. In this example, a lid controller hub could be located in either or both of the primary and secondary display portions. For example, a first LCH could be located in the secondary display that communicates to the base via wires that pass through the first hinge and a second LCH could be located in the primary display that communicates to the base via wires passing through the first and second hinge.

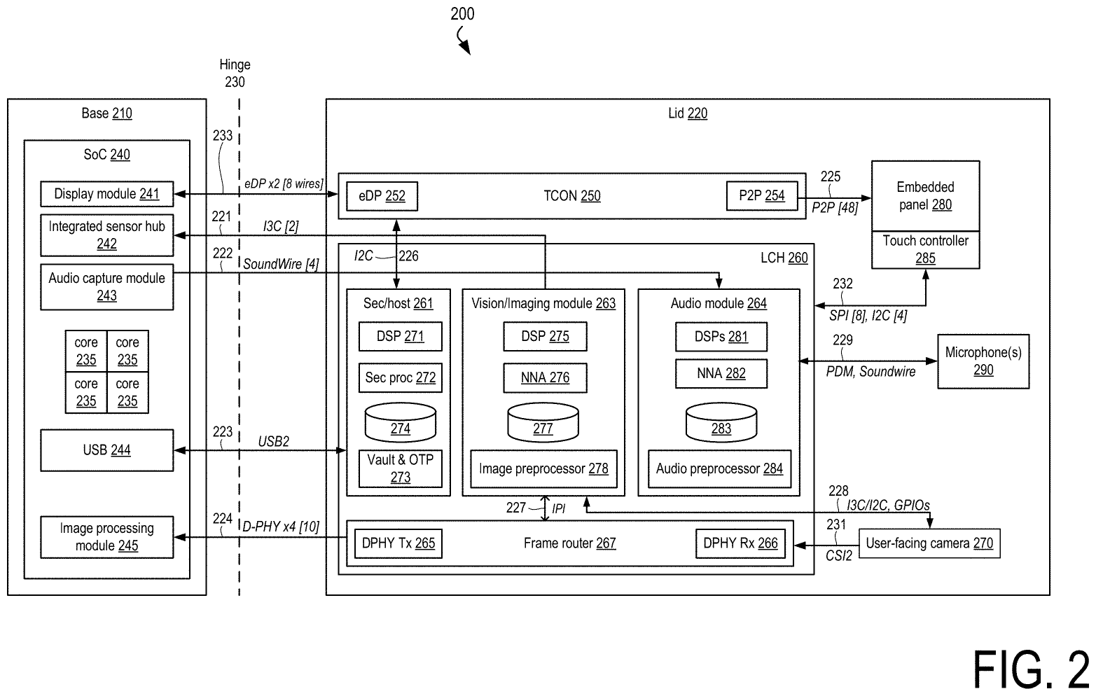

FIG. 2 illustrates a block diagram of a third example mobile computing device comprising a lid controller hub. The device 200 comprises a base 210 connected to a lid 220 by a hinge 230. The base 210 comprises an SoC 240. The lid 220 comprises a timing controller (TCON) 250, a lid controller hub (LCH) 260, a user-facing camera 270, an embedded display panel 280, and one or more microphones 290.

The SoC 240 comprises a display module 241, an integrated sensor hub 242, an audio capture module 243, a Universal Serial Bus (USB) module 244, an image processing module 245, and a plurality of processor cores 235. The display module 241 communicates with an embedded DisplayPort (eDP) module in the TCON 250 via an eight-wire eDP connection 233. In some embodiments, the embedded display panel 280 is a “3K2K” display (a display having a 3K×2K resolution) with a refresh rate of up to 120 Hz and the connection 233 comprises two eDP High Bit Rate 2 (HBR2 (17.28 Gb/s)) connections. The integrated sensor hub 242 communicates with a vision/imaging module 263 of the LCH 260 via a two-wire Mobile Industry Processor Interface (MIPI) I3C (SenseWire) connection 221, the audio capture module 243 communicates with an audio module 264 of the LCH 260 via a four-wire MIPI SoundWire® connection 222, the USB module 244 communicates with a security/host module 261 of the LCH 260 via a USB connection 223, and the image processing module 245 receives image data from a MIPI D-PHY transmit port 265 of a frame router 267 of the LCH 260 via a four-lane MIPI D-PHY connection 224 comprising 10 wires. The integrated sensor hub 242 can be an Intel® integrated sensor hub or any other sensor hub capable of processing sensor data from one or more sensors.

The TCON 250 comprises the eDP port 252 and a Peripheral Component Interface Express (PCIe) port 254 that drives the embedded display panel 280 using PCIe's peer-to-peer (P2P) communication feature over a 48-wire connection 225.

The LCH 260 comprises the security/host module 261, the vision/imaging module 263, the audio module 264, and a frame router 267. The security/host module 261 comprises a digital signal processing (DSP) processor 271, a security processor 272, a vault and one-time password generator (OTP) 273, and a memory 274. In some embodiments, the DSP 271 is a Synopsis® DesignWare® ARC® EM7D or EM11D DSP processor and the security processor is a Synopsis® DesignWare® ARC® SEM security processor. In addition to being in communication with the USB module 244 in the SoC 240, the security/host module 261 communicates with the TCON 250 via an inter-integrated circuit (I2C) connection 226 to provide for synchronization between LCH and TCON activities. The memory 274 stores instructions executed by components of the LCH 260.

The vision/imaging module 263 comprises a DSP 275, a neural network accelerator (NNA) 276, an image preprocessor 278, and a memory 277. In some embodiments, the DSP 275 is a DesignWare® ARC® EM11D processor. The vising/imaging module 263 communicates with the frame router 267 via an intelligent peripheral interface (IPI) connection 227. The vision/imaging module 263 can perform face detection, detect head orientation, and enables device access based on detecting a person's face (Wake on Face) or an authorized user's face (Face ID) in image sensor data. In some embodiments, the vision/imaging module 263 can implement one or more artificial intelligence (AI) models via the neural network accelerators 276 to enable these functions. For example, the neural network accelerator 276 can implement a model trained to recognize an authorized user's face in image sensor data to enable a Wake on Face feature. The vision/imaging module 263 communicates with the camera 270 via a connection 228 comprising a pair of I2C or I3C wires and a five-wire general-purpose I/O (GPIO) connection. The frame router 267 comprises the D-PHY transmit port 265 and a D-PHY receiver 266 that receives image sensor data provided by the user-facing camera 270 via a connection 231 comprising a four-wire MIPI Camera Serial Interface 2 (CSI2) connection. The LCH 260 communicates with a touch controller 285 via a connection 232 that can comprise an eight-wire serial peripheral interface (SPI) or a four-wire I2C connection.

The audio module 264 comprises one or more DSPs 281, a neural network accelerator 282, an audio preprocessor 284, and a memory 283. In some embodiments, the lid 220 comprises four microphones 290 and the audio module 264 comprises four DSPs 281, one for each microphone. In some embodiments, each DSP 281 is a Cadence® Tensilica® HiFi DSP. The audio module 264 communicates with the one or more microphones 290 via a connection 229 that comprises a MIPI SoundWire® connection or signals sent via pulse-density modulation (PDM). In other embodiments, the connection 229 comprises a four-wire digital microphone (DMIC) interface, a two-wire integrated inter-IC sound bus (I2S) connection, and one or more GPIO wires. The audio module 264 enables waking the device from a low-power state upon detecting a human voice (Wake on Voice) or the voice of an authenticated user (Speaker ID), near- and far-field audio (input and output), and can perform additional speech recognition tasks. In some embodiments, the NNA 282 is an artificial neural network accelerator implementing one or more artificial intelligence (AI) models to enable various LCH functions. For example, the NNA 282 can implement an AI model trained to detect a wake word or phrase in audio sensor data generated by the one or more microphones 290 to enable a Wake on Voice feature.

In some embodiments, the security/host module memory 274, the vision/imaging module memory 277, and the audio module memory 283 are part of a shared memory accessible to the security/host module 261, the vision/imaging module 263, and the audio module 264. During startup of the device 200, a section of the shared memory is assigned to each of the security/host module 261, the vision/imaging module 263, and the audio module 264. After startup, each section of shared memory assigned to a module is firewalled from the other assigned sections. In some embodiments, the shared memory can be a 12 MB memory partitioned as follows: security/host memory (1 MB), vision/imaging memory (3 MB), and audio memory (8 MB).

Any connection described herein connecting two or more components can utilize a different interface, protocol, or connection technology and/or utilize a different number of wires than that described for a particular connection. Although the display module 241, integrated sensor hub 242, audio capture module 243, USB module 244, and image processing module 245 are illustrated as being integrated into the SoC 240, in other embodiments, one or more of these components can be located external to the SoC. For example, one or more of these components can be located on a die, in a package, or on a board separate from a die, package, or board comprising host processor units (e.g., cores 235).

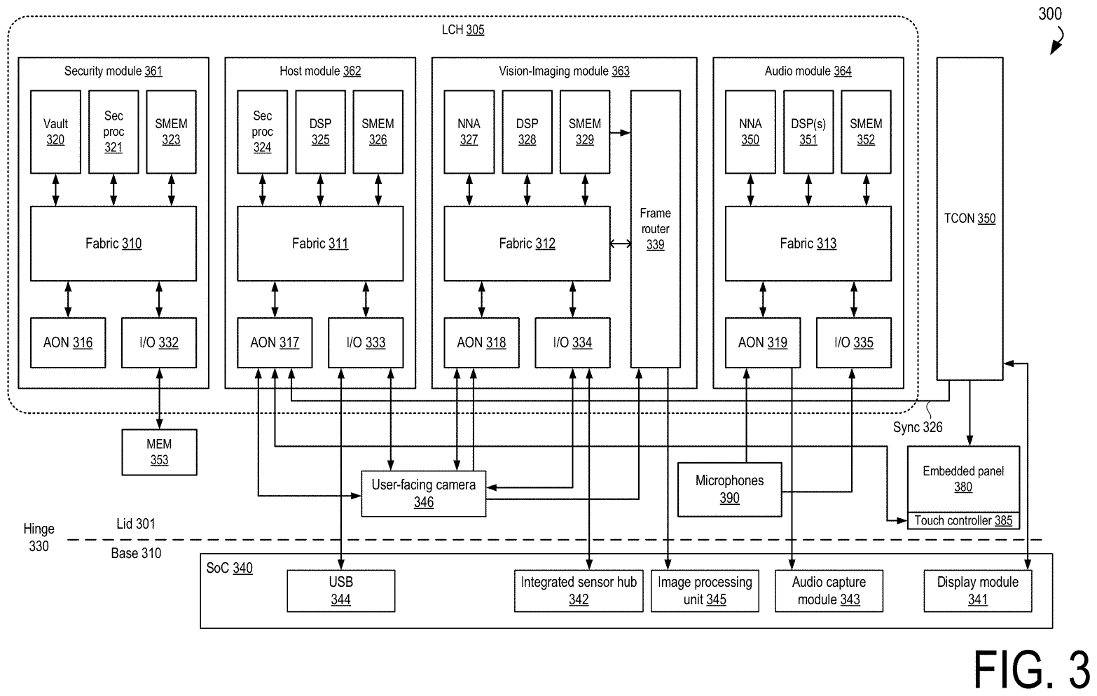

FIG. 3 illustrates a block diagram of a fourth example mobile computing device comprising a lid controller hub. The mobile computing device 300 comprises a lid 301 connected to a base 315 via a hinge 330. The lid 301 comprises a lid controller hub (LCH) 305, a timing controller 355, a user-facing camera 346, microphones 390, an embedded display panel 380, a touch controller 385, and a memory 353. The LCH 305 comprises a security module 361, a host module 362, a vision/imaging module 363, and an audio module 364. The security module 361 provides a secure processing environment for the LCH 305 and comprises a vault 320, a security processor 321, a fabric 310, I/Os 332, an always-on (AON) block 316, and a memory 323. The security module 361 is responsible for loading and authenticating firmware stored in the memory 353 and executed by various components (e.g., DSPs, neural network accelerators) of the LCH 305. The security module 361 authenticates the firmware by executing a cryptographic hash function on the firmware and making sure the resulting hash is correct and that the firmware has a proper signature using key information stored in the security module 361. The cryptographic hash function is executed by the vault 320. In some embodiments, the vault 320 comprises a cryptographic accelerator. In some embodiments, the security module 361 can present a product root of trust (PRoT) interface by which another component of the device 200 can query the LCH 305 for the results of the firmware authentication. In some embodiments, a PRoT interface can be provided over an I2C/I3C interface (e.g., I2C/I3C interface 470).

As used herein, the terms “operating”, “executing”, or “running” as they pertain to software or firmware in relation to a lid controller hub, a lid controller hub component, host processor unit, SoC, or other computing device component are used interchangeably and can refer to software or firmware stored in one or more computer-readable storage media accessible by the computing device component, even though the instructions contained in the software or firmware are not being actively executed by the component.

The security module 361 also stores privacy information and handles privacy tasks. In some embodiments, information that the LCH 305 uses to perform Face ID or Speaker ID to wake a computing device if an authenticated user's voice is picked up by the microphone or if an authenticated user's face is captured by a camera is stored in the security module 361. The security module 361 also enables privacy modes for an LCH or a computing device. For example, if user input indicates that a user desires to enable a privacy mode, the security module 361 can disable access by LCH resources to sensor data generated by one or more of the lid input devices (e.g., touchscreen, microphone, camera). In some embodiments, a user can set a privacy setting to cause a device to enter a privacy mode. Privacy settings include, for example, disabling video and/or audio input in a videoconferencing application or enabling an operating system level privacy setting that prevents any application or the operating system from receiving and/or processing sensor data. Setting an application or operating system privacy setting can cause information to be sent to the lid controller hub to cause the LCH to enter a privacy mode. In a privacy mode, the lid controller hub can cause an input sensor to enter a low-power state, prevent LCH resources from processing sensor data or prevent raw or processed sensor data from being sent to a host processing unit.

In some embodiments, the LCH 305 can enable Wake on Face or Face ID features while keeping image sensor data private from the remainder of the system (e.g., the operating system and any applications running on the operating system). In some embodiments, the vision/imaging module 363 continues to process image sensor data to allow Wake on Face or Face ID features to remain active while the device is in a privacy mode. In some embodiments, image sensor data is passed through the vision/imaging module 363 to an image processing module 345 in the SoC 340 only when a face (or an authorized user's face) is detected, irrespective of whether a privacy mode is enabled, for enhanced privacy and reduced power consumption. In some embodiments, the mobile computing device 300 can comprise one or more world-facing cameras in addition to user-facing camera 346 as well as one or more world-facing microphones (e.g., microphones incorporated into the “A cover” of a laptop).

In some embodiments, the lid controller hub 305 enters a privacy mode in response to a user pushing a privacy button, flipping a privacy switch, or sliding a slider over an input sensor in the lid. In some embodiments, a privacy indicator can be provided to the user to indicate that the LCH is in a privacy mode. A privacy indicator can be, for example, an LED located in the base or display bezel or a privacy icon displayed on a display. In some embodiments, a user activating an external privacy button, switch, slider, hotkey, etc. enables a privacy mode that is set at a hardware level or system level. That is, the privacy mode applies to all applications and the operating system operating on the mobile computing device. For example, if a user presses a privacy switch located in the bezel of the lid, the LCH can disable all audio sensor data and all image sensor data from being made available to the SoC in response. Audio and image sensor data is still available to the LCH to perform tasks such as Wake of Voice and Speaker ID, but the audio and image sensor data accessible to the lid controller hub is not accessible to other processing components.

The host module 362 comprises a security processor 324, a DSP 325, a memory 326, a fabric 311, an always-on block 317, and I/Os 333. In some embodiments, the host module 362 can boot the LCH, send LCH telemetry and interrupt data to the SoC, manage interaction with the touch controller 385, and send touch sensor data to the SoC 340. The host module 362 sends lid sensor data from multiple lid sensors over a USB connection to a USB module 344 in the SoC 340. Sending sensor data for multiple lid sensors over a single connection contributes to the reduction in the number of wires passing through the hinge 330 relative to existing laptop designs. The DSP 325 processes touch sensor data received from the touch controller 385. The host module 362 can synchronize the sending of touch sensor data to the SoC 340 with the display panel refresh rate by utilizing a synchronization signal 370 shared between the TCON 355 and the host module 362.

The host module 362 can dynamically adjust the refresh rate of the display panel 380 based on factors such as user presence and the amount of user touch interaction with the panel 380. For example, the host module 362 can reduce the refresh rate of the panel 380 if no user is detected or an authorized user is not detected in front of the camera 346. In another example, the refresh rate can be increased in response to detection of touch interaction at the panel 380 based on touch sensor data. In some embodiments and depending upon the refresh rate capabilities of the display panel 380, the host module 362 can cause the refresh rate of the panel 380 to be increased up to 120 Hz or down to 20 Hz or less.

The host module 362 can also adjust the refresh rate based on the application that a user is interacting with. For example, if the user is interacting with an illustration application, the host module 362 can increase the refresh rate (which can also increase the rate at which touch data is sent to the SoC 340 if the display panel refresh rate and the processing of touch sensor data are synchronized) to 120 Hz to provide for a smoother touch experience to the user. Similarly, if the host module 362 detects that the application that a user is currently interacting with is one where the content is relatively static or is one that involves a low degree of user touch interaction or simple touch interactions (e.g., such as selecting an icon or typing a message), the host module 362 can reduce the refresh rate to a lower frequency. In some embodiments, the host module 362 can adjust the refresh rate and touch sampling frequency by monitoring the frequency of touch interaction. For example, the refresh rate can be adjusted upward if there is a high degree of user interaction or if the host module 362 detects that the user is utilizing a specific touch input device (e.g., a stylus) or a particular feature of a touch input stylus (e.g., a stylus' tilt feature). If supported by the display panel, the host module 362 can cause a strobing feature of the display panel to be enabled to reduce ghosting once the refresh rate exceeds a threshold value.

The vision/imaging module 363 comprises a neural network accelerator 327, a DSP 328, a memory 329, a fabric 312, an AON block 318, I/Os 334, and a frame router 339. The vision/imaging module 363 interacts with the user-facing camera 346. The vision/imaging module 363 can interact with multiple cameras and consolidate image data from multiple cameras into a single stream for transmission to an integrated sensor hub 342 in the SoC 340. In some embodiments, the lid 301 can comprise one or more additional user-facing cameras and/or world-facing cameras in addition to user-facing camera 346. In some embodiments, any of the user-facing cameras can be in-display cameras. Image sensor data generated by the camera 346 is received by the frame router 339 where it undergoes preprocessing before being sent to the neural network accelerator 327 and/or the DSP 328. The image sensor data can also be passed through the frame router 339 to an image processing module 345 in the SoC 340. The neural network accelerator 327 and/or the DSP 328 enable face detection, head orientation detection, the recognition of facial landmarks (e.g., eyes, cheeks, eyebrows, nose, mouth), the generation of a 3D mesh that fits a detected face, along with other image processing functions. In some embodiments, facial parameters (e.g., location of facial landmarks, 3D meshes, face physical dimensions, head orientation) can be sent to the SoC at a rate of 30 frames per second (30 fps).

The audio module 364 comprises a neural network accelerator 350, one or more DSPs 351, a memory 352, a fabric 313, an AON block 319, and I/Os 335. The audio module 364 receives audio sensor data from the microphones 390. In some embodiments, there is one DSP 351 for each microphone 390. The neural network accelerator 350 and DSP 351 implement audio processing algorithms and AI models that improve audio quality. For example, the DSPs 351 can perform audio preprocessing on received audio sensor data to condition the audio sensor data for processing by audio AI models implemented by the neural network accelerator 350. One example of an audio AI model that can be implemented by the neural network accelerator 350 is a noise reduction algorithm that filters out background noises, such as the barking of a dog or the wailing of a siren. A second example is models that enable Wake on Voice or Speaker ID features. A third example is context awareness models. For example, audio contextual models can be implemented that classify the occurrence of an audio event relating to a situation where law enforcement or emergency medical providers are to be summoned, such as the breaking of glass, a car crash, or a gun shot. The LCH can provide information to the SoC indicating the occurrence of such an event and the SoC can query to the user whether authorities or medical professionals should be summoned.

The AON blocks 316-319 in the LCH modules 361-364 comprises various I/Os, timers, interrupts, and control units for supporting LCH “always-on” features, such as Wake on Voice, Speaker ID, Wake on Face, and Face ID and an always-on display that is visible and presents content when the lid 301 is closed.

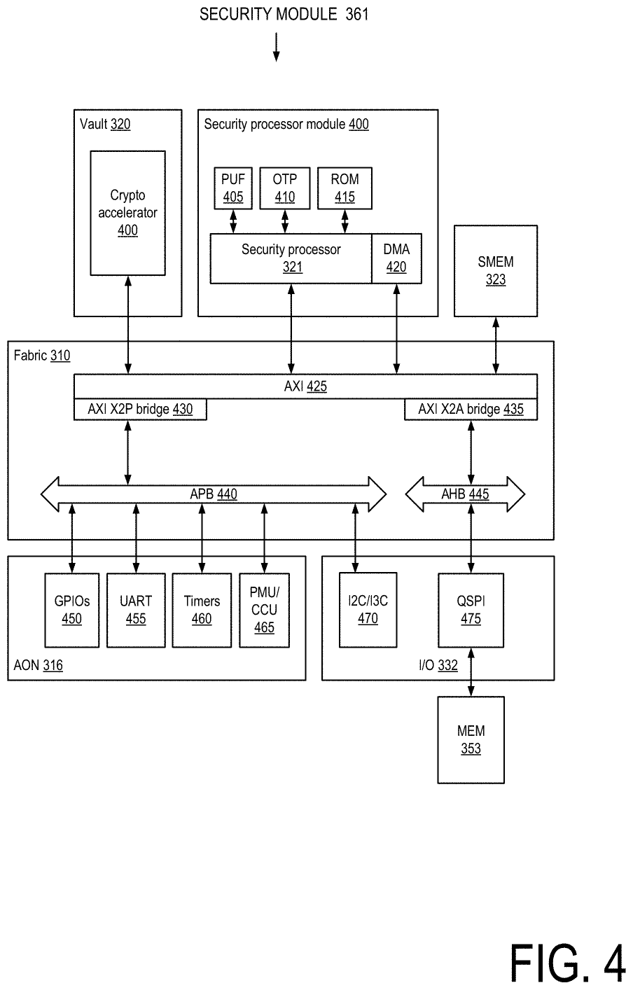

FIG. 4 illustrates a block diagram of the security module of the lid controller hub of FIG. 3. The vault 320 comprises a cryptographic accelerator 400 that can implement the cryptographic hash function performed on the firmware stored in the memory 353. In some embodiments, the cryptographic accelerator 400 implements a 128-bit block size advanced encryption standard (AES)-compliant (AES-128) or a 384-bit secure hash algorithm (SHA)-complaint (SHA-384) encryption algorithm. The security processor 321 resides in a security processor module 402 that also comprises a platform unique feature module (PUF) 405, an OTP generator 410, a ROM 415, and a direct memory access (DMA) module 420. The PUF 405 can implement one or more security-related features that are unique to a particular LCH implementation. In some embodiments, the security processor 321 can be a DesignWare® ARC® SEM security processor. The fabric 310 allows for communication between the various components of the security module 361 and comprises an advanced extensible interface (AXI) 425, an advanced peripheral bus (APB) 440, and an advanced high-performance bus (AHB) 445. The AXI 425 communicates with the advanced peripheral bus 440 via an AXI to APB (AXI X2P) bridge 430 and the advanced high-performance bus 445 via an AXI to AHB (AXI X2A) bridge 435. The always-on block 316 comprises a plurality of GPIOs 450, a universal asynchronous receiver-transmitter (UART) 455, timers 460, and power management and clock management units (PMU/CMU) 465. The PMU/CMU 465 controls the supply of power and clock signals to LCH components and can selectively supply power and clock signals to individual LCH components so that only those components that are to be in use to support a particular LCH operational mode or feature receive power and are clocked. The I/O set 332 comprises an I2C/I3C interface 470 and a queued serial peripheral interface (QSPI) 475 to communicate to the memory 353. In some embodiments, the memory 353 is a 16 MB serial peripheral interface (SPI)-NOR flash memory that stores the LCH firmware. In some embodiments, an LCH security module can exclude one or more of the components shown in FIG. 4. In some embodiments, an LCH security module can comprise one or more additional components beyond those shown in FIG. 4.

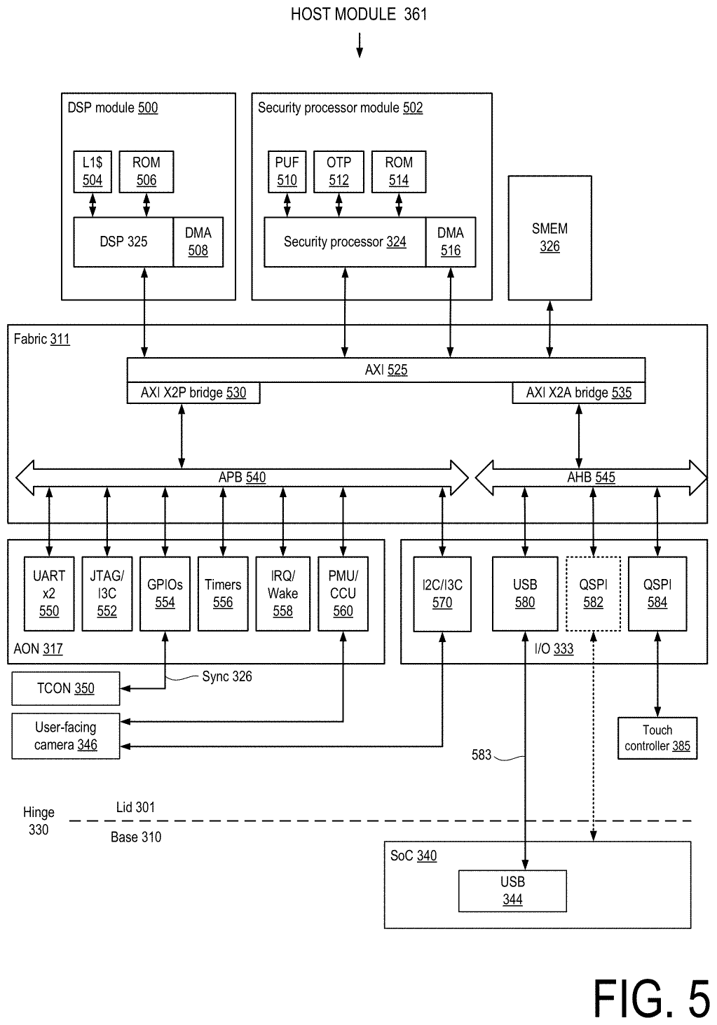

FIG. 5 illustrates a block diagram of the host module of the lid controller hub of FIG. 3. The DSP 325 is part of a DSP module 500 that further comprises a level one (L1) cache 504, a ROM 506, and a DMA module 508. In some embodiments, the DSP 325 can be a DesignWare® ARC® EM11D DSP processor. The security processor 324 is part of a security processor module 502 that further comprises a PUF module 510 to allow for the implementation of platform-unique functions, an OTP generator 512, a ROM 514, and a DMA module 516. In some embodiments, the security processor 324 is a Synopsis® DesignWare® ARC® SEM security processor. The fabric 311 allows for communication between the various components of the host module 362 and comprises similar components as the security component fabric 310. The always-on block 317 comprises a plurality of UARTs 550, a Joint Test Action Group (JTAG)/I3C port 552 to support LCH debug, a plurality of GPIOs 554, timers 556, an interrupt request (IRQ)/wake block 558, and a PMU/CCU port 560 that provides a 19.2 MHz reference clock to the camera 346. The synchronization signal 370 is connected to one of the GPIO ports. Ms 333 comprises an interface 570 that supports I2C and/or I3C communication with the camera 346, a USB module 580 that communicates with the USB module 344 in the SoC 340, and a QSPI block 584 that communicates with the touch controller 385. In some embodiments, the I/O set 333 provides touch sensor data with the SoC via a QSPI interface 582. In other embodiments, touch sensor data is communicated with the SoC over the USB connection 583. In some embodiments, the connection 583 is a USB 2.0 connection. By leveraging the USB connection 583 to send touch sensor data to the SoC, the hinge 330 is spared from having to carry the wires that support the QSPI connection supported by the QSPI interface 582. Not having to support this additional QSPI connection can reduce the number of wires crossing the hinge by four to eight wires.

In some embodiments, the host module 362 can support dual displays. In such embodiments, the host module 362 communicates with a second touch controller and a second timing controller. A second synchronization signal between the second timing controller and the host module allows for the processing of touch sensor data provided by the second touch controller and the sending of touch sensor data provided by the second touch sensor delivered to the SoC to be synchronized with the refresh rate of the second display. In some embodiments, the host module 362 can support three or more displays. In some embodiments, an LCH host module can exclude one or more of the components shown in FIG. 5. In some embodiments, an LCH host module can comprise one or more additional components beyond those shown in FIG. 5.

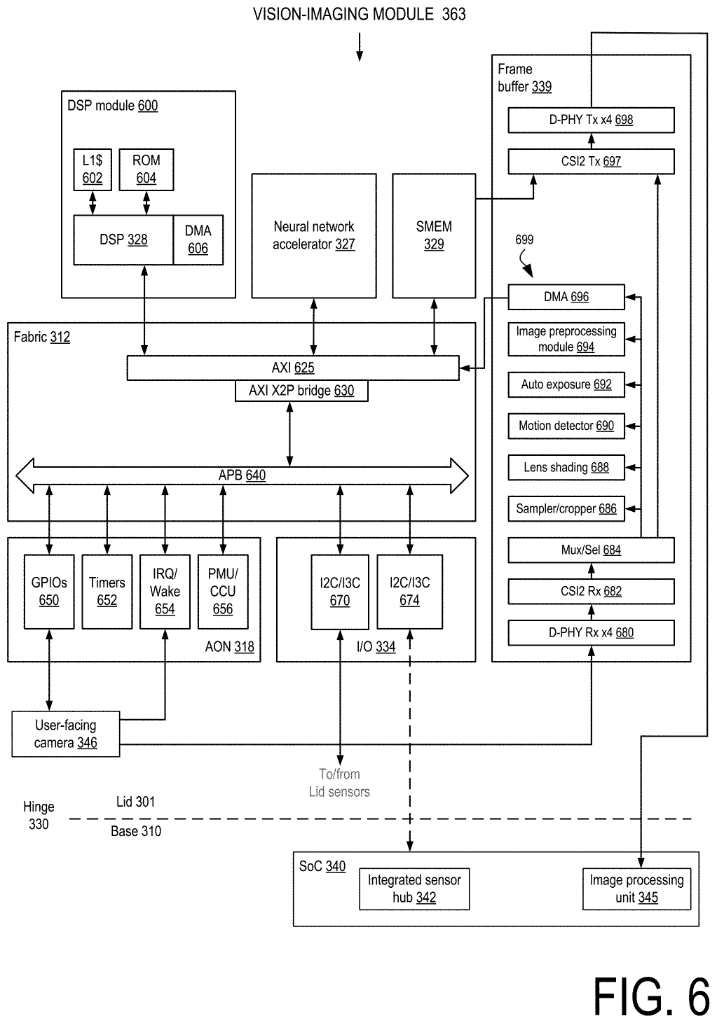

FIG. 6 illustrates a block diagram of the vision/imaging module of the lid controller hub of FIG. 3. The DSP 328 is part of a DSP module 600 that further comprises an L1 cache 602, a ROM 604, and a DMA module 606. In some embodiments, the DSP 328 can be a DesignWare® ARC® EM11D DSP processor. The fabric 312 allows for communication between the various components of the vision/imaging module 363 and comprises an advanced extensible interface (AXI) 625 connected to an advanced peripheral bus (APB) 640 by an AXI to APB (X2P) bridge 630. The always-on block 318 comprises a plurality of GPIOs 650, a plurality of timers 652, an IRQ/wake block 654, and a PMU/CCU 656. In some embodiments, the IRQ/wake block 654 receives a Wake on Motion (WoM) interrupt from the camera 346. The WoM interrupt can be generated based on accelerometer sensor data generated by an accelerator located in or communicatively coupled to the camera or generated in response to the camera performing motion detection processing in images captured by the camera. The I/Os 334 comprise an I2C/I3C interface 674 that sends metadata to the integrated sensor hub 342 in the SoC 340 and an I2C3/I3C interface 670 that connects to the camera 346 and other lid sensors 671 (e.g., radar sensor, time-of-flight camera, infrared). The vision/imaging module 363 can receive sensor data from the additional lid sensors 671 via the I2C/I3C interface 670. In some embodiments, the metadata comprises information such as information indicating whether information being provided by the lid controller hub is valid, information indicating an operational mode of the lid controller hub (e.g., off, a “Wake on Face” low power mode in which some of the LCH components are disabled but the LCH continually monitors image sensor data to detect a user's face), auto exposure information (e.g., the exposure level automatically set by the vision/imaging module 363 for the camera 346), and information relating to faces detected in images or video captured by the camera 346 (e.g., information indicating a confidence level that a face is present, information indicating a confidence level that the face matches an authorized user's face, bounding box information indicating the location of a face in a captured image or video, orientation information indicating an orientation of a detected face, and facial landmark information).

The frame router 339 receives image sensor data from the camera 346 and can process the image sensor data before passing the image sensor data to the neural network accelerator 327 and/or the DSP 328 for further processing. The frame router 339 also allows the received image sensor data to bypass frame router processing and be sent to the image processing module 345 in the SoC 340. Image sensor data can be sent to the image processing module 345 concurrently with being processed by a frame router processing stack 699. Image sensor data generated by the camera 346 is received at the frame router 339 by a MIPI D-PHY receiver 680 where it is passed to a MIPI CSI2 receiver 682. A multiplexer/selector block 684 allows the image sensor data to be processed by the frame router processing stack 699, to be sent directly to a CSI2 transmitter 697 and a D-PHY transmitter 698 for transmission to the image processing module 345, or both.

The frame router processing stack 699 comprises one or more modules that can perform preprocessing of image sensor data to condition the image sensor data for processing by the neural network accelerator 327 and/or the DSP 328, and perform additional image processing on the image sensor data. The frame router processing stack 699 comprises a sampler/cropper module 686, a lens shading module 688, a motion detector module 690, an auto exposure module 692, an image preprocessing module 694, and a DMA module 696. The sampler/cropper module 686 can reduce the frame rate of video represented by the image sensor data and/or crops the size of images represented by the image sensor data. The lens shading module 688 can apply one or more lens shading effect to images represented by the image sensor data. In some embodiments, a lens shading effects to be applied to the images represented by the image sensor data can be user selected. The motion detector 690 can detect motion across multiple images represented by the image sensor data. The motion detector can indicate any motion or the motion of a particular object (e.g., a face) over multiple images.

The auto exposure module 692 can determine whether an image represented by the image sensor data is over-exposed or under-exposed and cause the exposure of the camera 346 to be adjusted to improve the exposure of future images captured by the camera 346. In some embodiments, the auto exposure module 362 can modify the image sensor data to improve the quality of the image represented by the image sensor data to account for over-exposure or under-exposure. The image preprocessing module 694 performs image processing of the image sensor data to further condition the image sensor data for processing by the neural network accelerator 327 and/or the DSP 328. After the image sensor data has been processed by the one or more modules of the frame router processing stack 699 it can be passed to other components in the vision/imaging module 363 via the fabric 312. In some embodiments, the frame router processing stack 699 contains more or fewer modules than those shown in FIG. 6. In some embodiments, the frame router processing stack 699 is configurable in that image sensor data is processed by selected modules of the frame processing stack. In some embodiments, the order in which modules in the frame processing stack operate on the image sensor data is configurable as well.

Once image sensor data has been processed by the frame router processing stack 699, the processed image sensor data is provided to the DSP 328 and/or the neural network accelerator 327 for further processing. The neural network accelerator 327 enables the Wake on Face function by detecting the presence of a face in the processed image sensor data and the Face ID function by detecting the presence of the face of an authenticated user in the processed image sensor data. In some embodiments, the NNA 327 is capable of detecting multiple faces in image sensor data and the presence of multiple authenticated users in image sensor data. The neural network accelerator 327 is configurable and can be updated with information that allows the NNA 327 to identify one or more authenticated users or identify a new authenticated user. In some embodiments, the NNA 327 and/or DSP 328 enable one or more adaptive dimming features. One example of an adaptive dimming feature is the dimming of image or video regions not occupied by a human face, a useful feature for video conferencing or video call applications. Another example is globally dimming a screen while a computing device is in an active state and a face is longer detected in front of the camera and then undimming the display when the face is again detected. If this latter adaptive dimming feature is extended to incorporate Face ID, the screen is undimmed only when an authenticated user is again detected.

In some embodiments, the frame router processing stack 699 comprises a super resolution module (not shown) that can upscale or downscale the resolution of an image represented by image sensor data. For example, in embodiments where image sensor data represents 1-megapixel images, a super resolution module can upscale the 1-megapixel images to higher resolution images before they are passed to the image processing module 345. In some embodiments, an LCH vision/imaging module can exclude one or more of the components shown in FIG. 6. In some embodiments, an LCH vision/imaging module can comprise one or more additional components beyond those shown in FIG. 6.

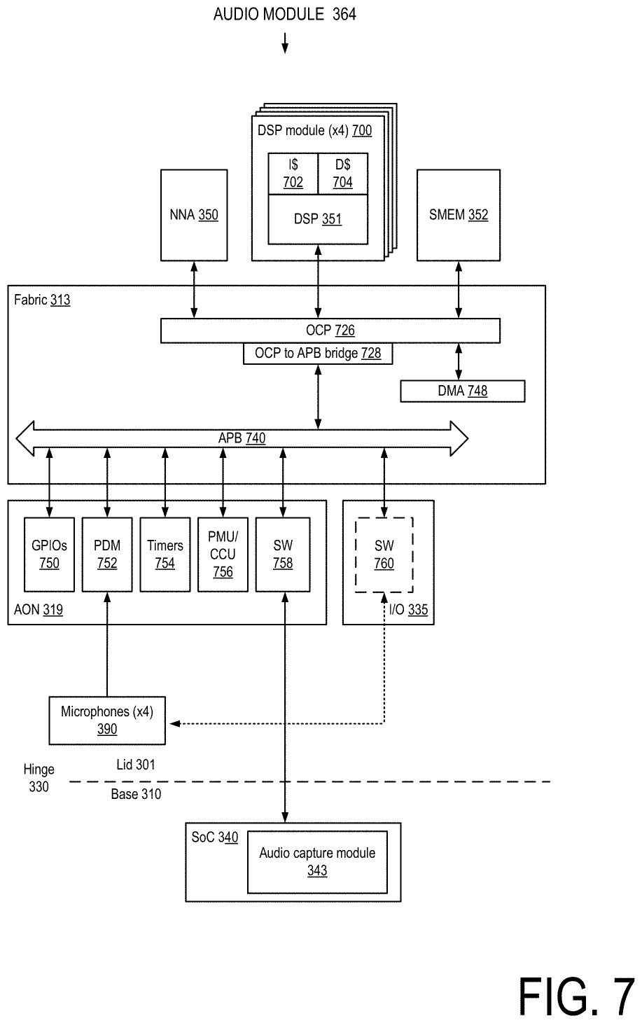

FIG. 7 illustrates a block diagram of the audio module 364 of the lid controller hub of FIG. 3. In some embodiments, the NNA 350 can be an artificial neural network accelerator. In some embodiments, the NNA 350 can be an Intel® Gaussian & Neural Accelerator (GNA) or other low-power neural coprocessor. The DSP 351 is part of a DSP module 700 that further comprises an instruction cache 702 and a data cache 704. In some embodiments, each DSP 351 is a Cadence® Tensilica® HiFi DSP. The audio module 364 comprises one DSP module 700 for each microphone in the lid. In some embodiments, the DSP 351 can perform dynamic noise reduction on audio sensor data. In other embodiments, more or fewer than four microphones can be used, and audio sensor data provided by multiple microphones can be processed by a single DSP 351. In some embodiments, the NNA 350 implements one or more models that improve audio quality. For example, the NNA 350 can implement one or more “smart mute” models that remove or reduce background noises that can be disruptive during an audio or video call.

In some embodiments, the DSPs 351 can enable far-field capabilities. For example, lids comprising multiple front-facing microphones distributed across the bezel (or over the display area if in-display microphones are used) can perform beamforming or spatial filtering on audio signals generated by the microphones to allow for far-field capabilities (e.g., enhanced detection of sound generated by a remote acoustic source). The audio module 364, utilizing the DSP 351s, can determine the location of a remote audio source to enhance the detection of sound received from the remote audio source location. In some embodiments, the DSPs 351 can determine the location of an audio source by determining delays to be added to audio signals generated by the microphones such that the audio signals overlap in time and then inferring the distance to the audio source from each microphone based on the delay added to each audio signal. By adding the determined delays to the audio signals provided by the microphones, audio detection in the direction of a remote audio source can be enhanced. The enhanced audio can be provided to the NNA 350 for speech detection to enable Wake on Voice or Speaker ID features. The enhanced audio can be subjected to further processing by the DSPs 351 as well. The identified location of the audio source can be provided to the SoC for use by the operating system or an application running on the operating system.

In some embodiments, the DSPs 351 can detect information encoded in audio sensor data at near-ultrasound (e.g., 15 kHz-20 kHz) or ultrasound (e.g., >20 kHz) frequencies, thus providing for a low-frequency low-power communication channel. Information detected in near-ultrasound/ultrasound frequencies can be passed to the audio capture module 343 in the SoC 340. An ultrasonic communication channel can be used, for example, to communicate meeting connection or Wi-Fi connection information to a mobile computing device by another computing device (e.g., Wi-Fi router, repeater, presentation equipment) in a meeting room. The audio module 364 can further drive the one or more microphones 390 to transmit information at ultrasonic frequencies. Thus, the audio channel can be used as a two-way low-frequency low-power communication channel between computing devices.

In some embodiments, the audio module 364 can enable adaptive cooling. For example, the audio module 364 can determine an ambient noise level and send information indicating the level of ambient noise to the SoC. The SoC can use this information as a factor in determining a level of operation for a cooling fan of the computing device. For example, the speed of a cooling fan can be scaled up or down with increasing and decreasing ambient noise levels, which can allow for increased cooling performance in noisier environments.

The fabric 313 allows for communication between the various components of the audio module 364. The fabric 313 comprises open core protocol (OCP) interfaces 726 to connect the NNA 550, the DSP modules 700, the memory 352 and the DMA 748 to the APB 740 via an OCP to APB bridge 728. The always-on block 319 comprises a plurality of GPIOs 750, a pulse density modulation (PDM) module 752 that receives audio sensor data generated by the microphones 390, one or more timers 754, a PMU/CCU 756, and a MIPI SoundWire® module 758 for transmitting and receiving audio data to the audio capture module 343. In some embodiments, audio sensor data provided by the microphones 390 is received at a DesignWare® SoundWire® module 760. In some embodiments, an LCH audio module can exclude one or more of the components shown in FIG. 7. In some embodiments, an LCH audio module can comprise one or more additional components beyond those shown in FIG. 7.

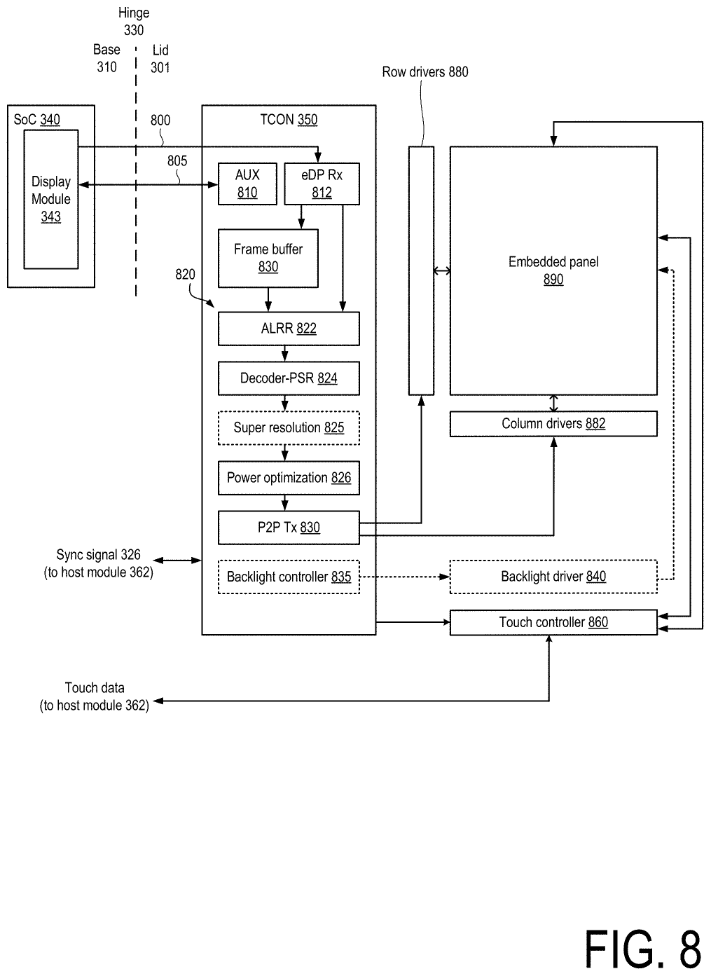

FIG. 8 illustrates a block diagram of the timing controller, embedded display panel, and additional electronics used in conjunction with the lid controller hub of FIG. 3. The timing controller 355 receives video data from the display module 341 of the SoC 340 over an eDP connection comprising a plurality of main link lanes 800 and an auxiliary (AUX) channel 805. Video data and auxiliary channel information provided by the display module 341 is received at the TCON 355 by an eDP main link receiver 812 and an auxiliary channel receiver 810 and. A timing controller processing stack 820 comprises one or more modules responsible for pixel processing and converting the video data sent from the display module 341 into signals that drive the control circuitry of the display panel 380, (e.g., row drivers 882, column drivers 884). Video data can be processed by timing controller processing stack 820 without being stored in a frame buffer 830 or video data can be stored in the frame buffer 830 before processing by the timing controller processing stack 820. The frame buffer 830 stores pixel information for one or more video frames (or frames, as used herein, the terms “image” and “frame” are used interchangeably). For example, in some embodiments, a frame buffer can store the color information for pixels in a video frame to be displayed on the panel.

The timing controller processing stack 820 comprises an autonomous low refresh rate module (ALRR) 822, a decoder-panel self-refresh (decoder-PSR) module 824, and a power optimization module 826. The ALRR module 822 can dynamically adjust the refresh rate of the display 380. In some embodiments, the ALRR module 822 can adjust the display refresh rate between 20 Hz and 120 Hz. The ALRR module 822 can implement various dynamic refresh rate approaches, such as adjusting the display refresh rate based on the frame rate of received video data, which can vary in gaming applications depending on the complexity of images being rendered. A refresh rate determined by the ALRR module 822 can be provided to the host module as the synchronization signal 370. In some embodiments, the synchronization signal comprises an indication that a display refresh is about to occur. In some embodiments, the ALRR module 822 can dynamically adjust the panel refresh rate by adjusting the length of the blanking period. In some embodiments, the ALRR module 822 can adjust the panel refresh rate based on information received from the host module 362. For example, in some embodiments, the host module 362 can send information to the ALRR module 822 indicating that the refresh rate is to be reduced if the vision/imaging module 363 determines there is no user in front of the camera. In some embodiments, the host module 362 can send information to the ALRR module 822 indicating that the refresh rate is to be increased if the host module 362 determines that there is touch interaction at the panel 380 based on touch sensor data received from the touch controller 385.

In some embodiments, the decoder-PSR module 824 can comprise a Video Electronics Standards Association (VESA) Display Streaming Compression (VDSC) decoder that decodes video data encoded using the VDSC compression standard. In other embodiments, the decoder-panel self-refresh module 824 can comprise a panel self-refresh (PSR) implementation that, when enabled, refreshes all or a portion of the display panel 380 based on video data stored in the frame buffer and utilized in a prior refresh cycle. This can allow a portion of the display pipeline leading up to the frame buffer to enter into a low-power state. In some embodiments, the decoder-panel self-refresh module 824 can be the PSR feature implemented in eDP v1.3 or the PSR2 feature implemented in eDP v1.4. In some embodiments, the TCON can achieve additional power savings by entering a zero or low refresh state when the mobile computing device operating system is being upgraded. In a zero-refresh state, the timing controller does not refresh the display. In a low refresh state, the timing controller refreshes the display at a slow rate (e.g., 20 Hz or less).

In some embodiments, the timing controller processing stack 820 can include a super resolution module 825 that can downscale or upscale the resolution of video frames provided by the display module 341 to match that of the display panel 380. For example, if the embedded panel 380 is a 3K×2K panel and the display module 341 provides 4K video frames rendered at 4K, the super resolution module 825 can downscale the 4K video frames to 3K×2K video frames. In some embodiments, the super resolution module 825 can upscale the resolution of videos. For example, if a gaming application renders images with a 1360×768 resolution, the super resolution module 825 can upscale the video frames to 3K×2K to take full advantage of the resolution capabilities of the display panel 380. In some embodiments, a super resolution module 825 that upscales video frames can utilize one or more neural network models to perform the upscaling.

The power optimization module 826 comprises additional algorithms for reducing power consumed by the TCON 355. In some embodiments, the power optimization module 826 comprises a local contrast enhancement and global dimming module that enhances the local contrast and applies global dimming to individual frames to reduce power consumption of the display panel 380.

In some embodiments, the timing controller processing stack 820 can comprise more or fewer modules than shown in FIG. 8. For example, in some embodiments, the timing controller processing stack 820 comprises an ALRR module and an eDP PSR2 module but does not contain a power optimization module. In other embodiments, modules in addition to those illustrated in FIG. 8 can be included in the timing controller stack 820. The modules included in the timing controller processing stack 820 can depend on the type of embedded display panel 380 included in the lid 301. For example, if the display panel 380 is a backlit liquid crystal display (LCD), the timing controller processing stack 820 would not include a module comprising the global dimming and local contrast power reduction approach discussed above as that approach is more amenable for use with emissive displays (displays in which the light emitting elements are located in individual pixels, such as QLED, OLED, and micro-LED displays) rather than backlit LCD displays. In some embodiments, the timing controller processing stack 820 comprises a color and gamma correction module.

After video data has been processed by the timing controller processing stack 820, a P2P transmitter 880 converts the video data into signals that drive control circuitry for the display panel 380. The control circuitry for the display panel 380 comprises row drivers 882 and column drivers 884 that drive rows and columns of pixels in a display 380 within the embedded 380 to control the color and brightness of individual pixels.

In embodiments where the embedded panel 380 is a backlit LCD display, the TCON 355 can comprise a backlight controller 835 that generates signals to drive a backlight driver 840 to control the backlighting of the display panel 380. The backlight controller 835 sends signals to the backlight driver 840 based on video frame data representing the image to be displayed on the panel 380. The backlight controller 835 can implement low-power features such as turning off or reducing the brightness of the backlighting for those portions of the panel (or the entire panel) if a region of the image (or the entire image) to be displayed is mostly dark. In some embodiments, the backlight controller 835 reduces power consumption by adjusting the chroma values of pixels while reducing the brightness of the backlight such that there is little or no visual degradation perceived by a viewer. In some embodiments the backlight is controlled based on signals send to the lid via the eDP auxiliary channel, which can reduce the number of wires sent across the hinge 330.

The touch controller 385 is responsible for driving the touchscreen technology of the embedded panel 380 and collecting touch sensor data from the display panel 380. The touch controller 385 can sample touch sensor data periodically or aperiodically and can receive control information from the timing controller 355 and/or the lid controller hub 305. The touch controller 385 can sample touch sensor data at a sampling rate similar or close to the display panel refresh rate. The touch sampling can be adjusted in response to an adjustment in the display panel refresh rate. Thus, if the display panel is being refreshed at a low rate or not being refreshed at all, the touch controller can be placed in a low-power state in which it is sampling touch sensor data at a low rate or not at all. When the computing device exits the low-power state in response to, for example, the vision/imaging module 363 detecting a user in the image data being continually analyzed by the vision/imaging module 363, the touch controller 385 can increase the touch sensor sampling rate or begin sampling touch sensor data again. In some embodiments, as will be discussed in greater detail below, the sampling of touch sensor data can be synchronized with the display panel refresh rate, which can allow for a smooth and responsive touch experience. In some embodiments, the touch controller can sample touch sensor data at a rate that is independent from the display refresh rate.

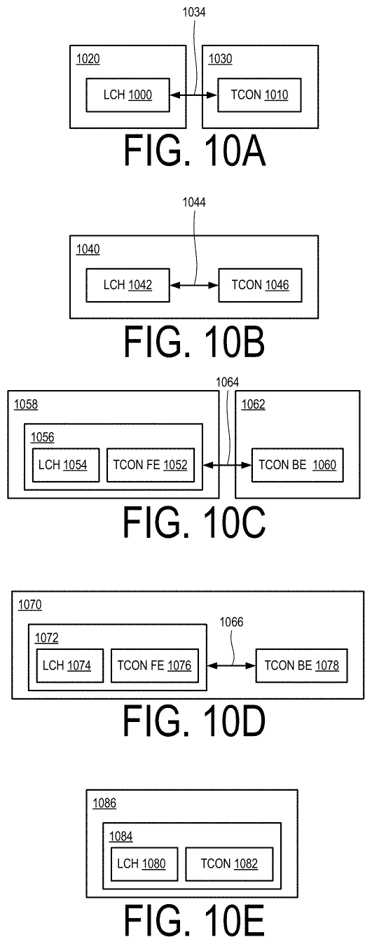

Although the timing controllers 250 and 351 of FIGS. 2 and 3 are illustrated as being separate from lid controller hubs 260 and 305, respectively, any of the timing controllers described herein can be integrated onto the same die, package, or printed circuit board as a lid controller hub. Thus, reference to a lid controller hub can refer to a component that includes a timing controller and reference to a timing controller can refer to a component within a lid controller hub. FIGS. 10A-10D illustrate various possible physical relationships between a timing controller and a lid controller hub.

In some embodiments, a lid controller hub can have more or fewer components and/or implement fewer features or capabilities than the LCH embodiments described herein. For example, in some embodiments, a mobile computing device may comprise an LCH without an audio module and perform processing of audio sensor data in the base. In another example, a mobile computing device may comprise an LCH without a vision/imaging module and perform processing of image sensor data in the base.

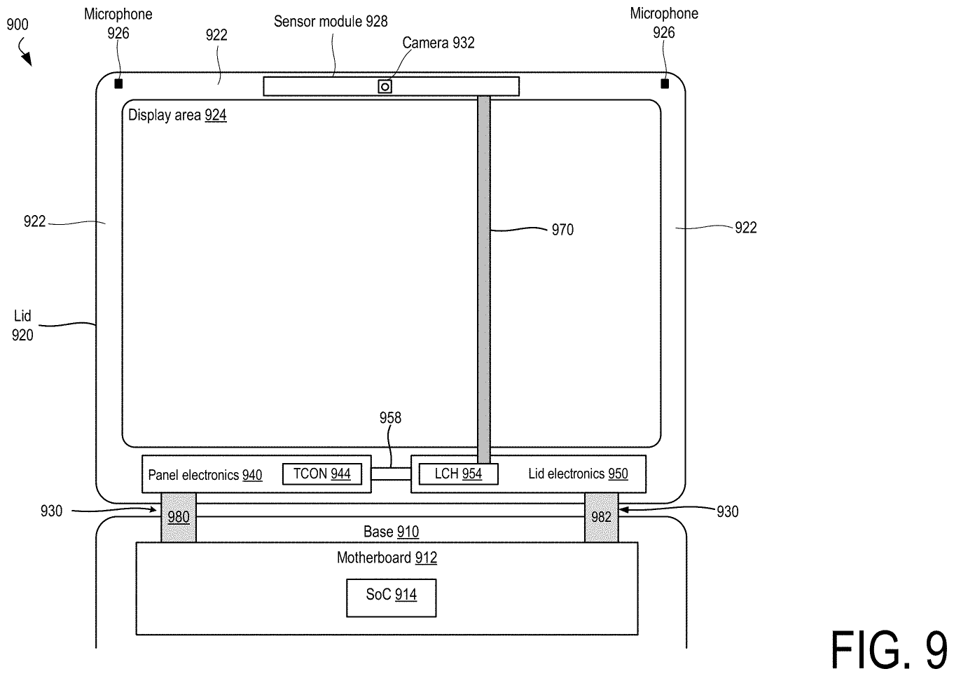

FIG. 9 illustrates a block diagram illustrating an example physical arrangement of components in a mobile computing device comprising a lid controller hub. The mobile computing device 900 comprises a base 910 connected to a lid 920 via a hinge 930. The base 910 comprises a motherboard 912 on which an SoC 914 and other computing device components are located. The lid 920 comprises a bezel 922 that extends around the periphery of a display area 924, which is the active area of an embedded display panel 927 located within the lid, e.g., the portion of the embedded display panel that displays content. The lid 920 further comprises a pair of microphones 926 in the upper left and right corners of the lid 920, and a sensor module 928 located along a center top portion of the bezel 922. The sensor module 928 comprises a front-facing camera 932. In some embodiments, the sensor module 928 is a printed circuit board on which the camera 932 is mounted. The lid 920 further comprises panel electronics 940 and lid electronics 950 located in a bottom portion of the lid 920. The lid electronics 950 comprises a lid controller hub 954 and the panel electronics 940 comprises a timing controller 944. In some embodiments the lid electronics 950 comprises a printed circuit board on which the LCH 954 in mounted. In some embodiments the panel electronics 940 comprises a printed circuit board upon which the TCON 944 and additional panel circuitry is mounted, such as row and column drivers, a backlight driver (if the embedded display is an LCD backlit display), and a touch controller. The timing controller 944 and the lid controller hub 954 communicate via a connector 958 which can be a cable connector connecting two circuit boards. The connector 958 can carry the synchronization signal that allows for touch sampling activities to be synchronized with the display refresh rate. In some embodiments, the LCH 954 can deliver power to the TCON 944 and other electronic components that are part of the panel electronics 940 via the connector 958. A sensor data cable 970 carries image sensor data generated by the camera 932, audio sensor data generated by the microphones 926, a touch sensor data generated by the touchscreen technology to the lid controller hub 954. Wires carrying audio signal data generated by the microphones 926 can extend from the microphones 926 in the upper and left corners of the lid to the sensor module 928, where they aggregated with the wires carrying image sensor data generated by the camera 932 and delivered to the lid controller hub 954 via the sensor data cable 970.

The hinge 930 comprises a left hinge portion 980 and a right hinge portion 982. The hinge 930 physically couples the lid 920 to the base 910 and allows for the lid 920 to be rotated relative to the base. The wires connecting the lid controller hub 954 to the base 910 pass through one or both of the hinge portions 980 and 982. Although shown as comprising two hinge portions, the hinge 930 can assume a variety of different configurations in other embodiments. For example, the hinge 930 could comprise a single hinge portion or more than two hinge portions, and the wires that connect the lid controller hub 954 to the SoC 914 could cross the hinge at any hinge portion. With the number of wires crossing the hinge 930 being less than in existing laptop devices, the hinge 930 can be less expensive and simpler component relative to hinges in existing laptops.

In other embodiments, the lid 920 can have different sensor arrangements than that shown in FIG. 9. For example, the lid 920 can comprise additional sensors such as additional front-facing cameras, a front-facing depth sensing camera, an infrared sensor, and one or more world-facing cameras. In some embodiments, the lid 920 can comprise additional microphones located in the bezel, or just one microphone located on the sensor module. The sensor module 928 can aggregate wires carrying sensor data generated by additional sensors located in the lid and deliver them to the sensor data cable 970, which delivers the additional sensor data to the lid controller hub 954.

In some embodiments, the lid comprises in-display sensors such as in-display microphones or in-display cameras. These sensors are located in the display area 924, in pixel area not utilized by the emissive elements that generate the light for each pixel and are discussed in greater detail below. The sensor data generated by in-display cameras and in-display microphones can be aggregated by the sensor module 928 as well as other sensor modules located in the lid and deliver the sensor data generated by the in-display sensors to the lid controller hub 954 for processing.

In some embodiments, one or more microphones and cameras can be located in a position within the lid that is convenient for use in an “always-on” usage scenario, such as when the lid is closed. For example, one or more microphones and cameras can be located on the “A cover” of a laptop or other world-facing surface (such as a top edge or side edge of a lid) of a mobile computing device when the device is closed to enable the capture and monitoring of audio or image data to detect the utterance of a wake word or phrase or the presence of a person in the field of view of the camera.

FIGS. 10A-10E illustrate block diagrams of example timing controller and lid controller hub physical arrangements within a lid. FIG. 10A illustrates a lid controller hub 1000 and a timing controller 1010 located on a first module 1020 that is physically separate from a second module 1030. In some embodiments, the first and second modules 1020 and 1030 are printed circuit boards. The lid controller hub 1000 and the timing controller 1010 communicate via a connection 1034. FIG. 10B illustrates a lid controller hub 1042 and a timing controller 1046 located on a third module 1040. The LCH 1042 and the TCON 1046 communicate via a connection 1044. In some embodiments, the third module 1040 is a printed circuit board and the connection 1044 comprises one or more printed circuit board traces. One advantage to taking a modular approach to lid controller hub and timing controller design is that it allows timing controller vendors to offer a single timing controller that works with multiple LCH designs having different feature sets.

FIG. 10C illustrates a timing controller split into front end and back end components. A timing controller front end (TCON FE) 1052 and a lid controller hub 1054 are integrated in or are co-located on a first common component 1056. In some embodiments, the first common component 1056 is an integrated circuit package and the TCON FE 1052 and the LCH 1054 are separate integrated circuit die integrated in a multi-chip package or separate circuits integrated on a single integrated circuit die. The first common component 1056 is located on a fourth module 1058 and a timing controller back end (TCON BE) 1060 is located on a fifth module 1062. The timing controller front end and back end components communicate via a connection 1064. Breaking the timing controller into front end and back end components can provide for flexibility in the development of timing controllers with various timing controller processing stacks. For example, a timing controller back end can comprise modules that drive an embedded display, such as the P2P transmitter 880 of the timing controller processing stack 820 in FIG. 8 and other modules that may be common to various timing controller frame processor stacks, such as a decoder or panel self-refresh module. A timing controller front end can comprise modules that are specific for a particular mobile device design. For example, in some embodiments, a TCON FE comprises a power optimization module 826 that performs global dimming and local contrast enhancement that is desired to be implemented in specific laptop models, or an ALRR module where it is convenient to have the timing controller and lid controller hub components that work in synchronization (e.g., via synchronization signal 370) to be located closer together for reduced latency.

FIG. 10D illustrates an embodiment in which a second common component 1072 and a timing controller back end 1078 are located on the same module, a sixth module 1070, and the second common component 1072 and the TCON BE 1078 communicate via a connection 1066. FIG. 10E illustrates an embodiment in which a lid controller hub 1080 and a timing controller 1082 are integrated on a third common component 1084 that is located on a seventh module 1086. In some embodiments, the third common component 1084 is an integrated circuit package and the LCH 1080 and TCON 1082 are individual integrated circuit die packaged in a multi-chip package or circuits located on a single integrated circuit die. In embodiments where the lid controller hub and the timing controller are located on physically separate modules (e.g., FIG. 10A, FIG. 10C), the connection between modules can comprise a plurality of wires, a flexible printed circuit, a printed circuit, or by one or more other components that provide for communication between modules.

The modules and components in FIGS. 10C-10E that comprise a lid controller hub and a timing controller (e.g., fourth module 1058, second common component 1072, and third common component 1084) can be referred to as a lid controller hub.

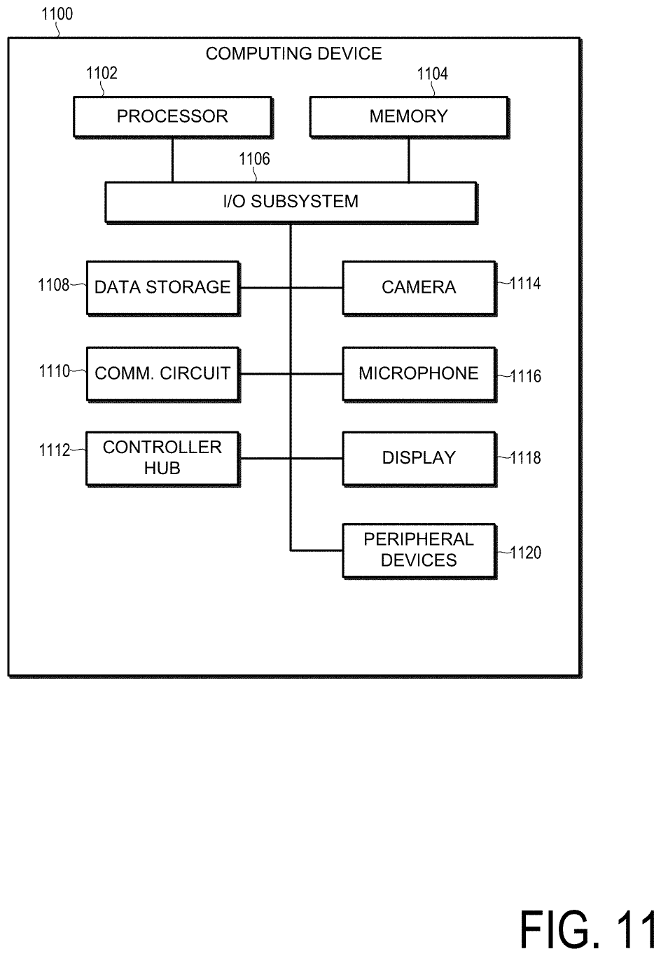

Referring now to FIG. 11, in one embodiment, a computing device 1100 for interfacing with a camera 1114 is shown. In use, in the illustrative embodiment, the camera 1114 of the computing device 1100 is connected to a controller hub 1112, which may be a lid controller hub, such as LCH 155, 260, 305, or 954. The controller hub 1112 may access images from the camera 1114 and/or may pass images from the camera to a host controller of the computing device 1100. In one embodiment, the controller hub 1112 may include a Universal Serial Bus (USB) multiplexer, allowing for the camera signal to be routed to a component in the controller hub 1112 or to the host controller of the computing device 1100 or to both. Additionally or alternatively, in some embodiments, the controller hub 1112 includes a host controller to interface with the camera 1114. The controller hub 1112 may include USB video class (UVC) functionality, allowing the host controller of the computing device to receive images from the camera 1114 as well.

The computing device 1100 may be embodied as any type of computing device. For example, the computing device 1100 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other computing device. In some embodiments, the computing device 1100 may be located in a data center, such as an enterprise data center (e.g., a data center owned and operated by a company and typically located on company premises), managed services data center (e.g., a data center managed by a third party on behalf of a company), a colocated data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

The illustrative computing device 1100 includes a processor 1102, a memory 1104, an input/output (I/O) subsystem 1106, data storage 1108, a communication circuit 1110, a controller hub 1112, a camera 1114, a microphone 1116, a display 1118, and one or more peripheral devices 1120. In some embodiments, one or more of the illustrative components of the computing device 1100 may be incorporated in, or otherwise form a portion of, another component. For example, the memory 1104, or portions thereof, may be incorporated in the processor 1102 in some embodiments. In some embodiments, one or more of the illustrative components may be physically separated from another component. In some embodiments, the computing device 1100 may be embodied as a computing device described above, such as computing device 100, 122, 200, 300, or 900. Accordingly, in some embodiments, the controller hub 1112 may be a lid controller hub, such as LCH 155, 260, 305, or 954.

The processor 1102 may be embodied as any type of processor capable of performing the functions described herein. For example, the processor 1102 may be embodied as a single or multi-core processor(s), a single or multi-socket processor, a digital signal processor, a graphics processor, a neural network compute engine, an image processor, a microcontroller, or other processor or processing/controlling circuit. Similarly, the memory 1104 may be embodied as any type of volatile or non-volatile memory or data storage capable of performing the functions described herein. In operation, the memory 1104 may store various data and software used during operation of the computing device 1100 such as operating systems, applications, programs, libraries, and drivers. The memory 1104 is communicatively coupled to the processor 1102 via the I/O subsystem 1106, which may be embodied as circuitry and/or components to facilitate input/output operations with the processor 1102, the memory 1104, and other components of the computing device 1100. For example, the I/O subsystem 1106 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. The I/O subsystem 1106 may connect various internal and external components of the computing device 1100 to each other with use of any suitable connector, interconnect, bus, protocol, etc., such as an SoC fabric, PCIe®, USB2, USB3, USB4, NVMe®, Thunderbolt®, and/or the like. In some embodiments, the I/O subsystem 1106 may form a portion of a system-on-a-chip (SoC) and be incorporated, along with the processor 1102, the memory 1104, and other components of the computing device 1100 on a single integrated circuit chip.

The data storage 1108 may be embodied as any type of device or devices configured for the short-term or long-term storage of data. For example, the data storage 1108 may include any one or more memory devices and circuits, memory cards, hard disk drives, solid-state drives, or other data storage devices.

The communication circuit 1110 may be embodied as any type of interface capable of interfacing the computing device 1100 with other computing devices, such as over one or more wired or wireless connections. In some embodiments, the communication circuit 1110 may be capable of interfacing with any appropriate cable type, such as an electrical cable or an optical cable. The communication circuit 1110 may be configured to use any one or more communication technology and associated protocols (e.g., Ethernet, Bluetooth®, Wi-Fi®, WiMAX, near field communication (NFC), etc.). The communication circuit 1110 may be located on silicon separate from the processor 1102, or the communication circuit 1110 may be included in a multi-chip package with the processor 1102, or even on the same die as the processor 1102. The communication circuit 1110 may be embodied as one or more add-in-boards, daughtercards, network interface cards, controller chips, chipsets, specialized components such as a field-programmable gate array (FPGA) or application-specific integrated circuit (ASIC), or other devices that may be used by the computing device 1102 to connect with another computing device. In some embodiments, communication circuit 1110 may be embodied as part of a system-on-a-chip (SoC) that includes one or more processors or included on a multichip package that also contains one or more processors. In some embodiments, the communication circuit 1110 may include a local processor (not shown) and/or a local memory (not shown) that are both local to the communication circuit 1110. In such embodiments, the local processor of the communication circuit 1110 may be capable of performing one or more of the functions of the processor 1102 described herein. Additionally or alternatively, in such embodiments, the local memory of the communication circuit 1110 may be integrated into one or more components of the computing device 1102 at the board level, socket level, chip level, and/or other levels.

The controller hub 1112 can be any collection of circuitry that can interface with one or more sensors and may include one or more modules that process or otherwise act upon sensor data. The controller hub 1112 may pass some or all of the sensor data to other components of the computing device, such as the memory 1104 or the processor 1102.

The camera 1114 can be any of the cameras described or referenced herein, such as cameras 160, 270, 346, and 932. In the illustrative embodiment, the camera 1114 is connected to the controller hub 1112, and other components of the computing device 1100 such as the processor 1102 may access images from the camera 1114 through the controller hub 1112. The camera 1114 may include one or more fixed or adjustable lenses and one or more image sensors. The image sensors may be any suitable type of image sensors, such as a CMOS or CCD image sensor. The camera 1114 may have any suitable aperture, focal length, field of view, etc. For example, the camera 1114 may have a field of view of 60-110° in the azimuthal and/or elevation directions. In the illustrative embodiment, the camera 1114 is a USB camera.

The microphone 1116 is configured to sense sound waves and output an electrical signal indicative of the sound waves. In the illustrative embodiment, the computing device 1100 may have more than one microphone 1116, such as an array of microphones 1116 in different positions. In the illustrative embodiment, the microphone 1116 is connected to the controller hub 1112, and other components of the computing device 1100 such as the processor 1102 may access images from the microphone 1116 through the controller hub 1112.

The display 1118 may be embodied as any type of display on which information may be displayed to a user of the computing device 1100, such as a touchscreen display, a liquid crystal display (LCD), a thin film transistor LCD (TFT-LCD), a light-emitting diode (LED) display, an organic light-emitting diode (OLED) display, a cathode ray tube (CRT) display, a plasma display, an image projector (e.g., 2D or 3D), a laser projector, a heads-up display, and/or other display technology. The display 1118 may have any suitable resolution, such as 7680×4320, 3840×2160, 1920×1200, 1920×1080, etc.

In some embodiments, the computing device 1100 may include other or additional components, such as those commonly found in a computing device. For example, the computing device 1100 may also have peripheral devices 1120, such as a keyboard, a mouse, a speaker, an external storage device, etc. In some embodiments, the computing device 1100 may be connected to a dock that can interface with various devices, including peripheral devices 1120. In some embodiments, the peripheral devices 1120 may include additional sensors that the computing device 1100 can use to monitor the video conference, such as a time-of-flight sensor or a millimeter-wave sensor.

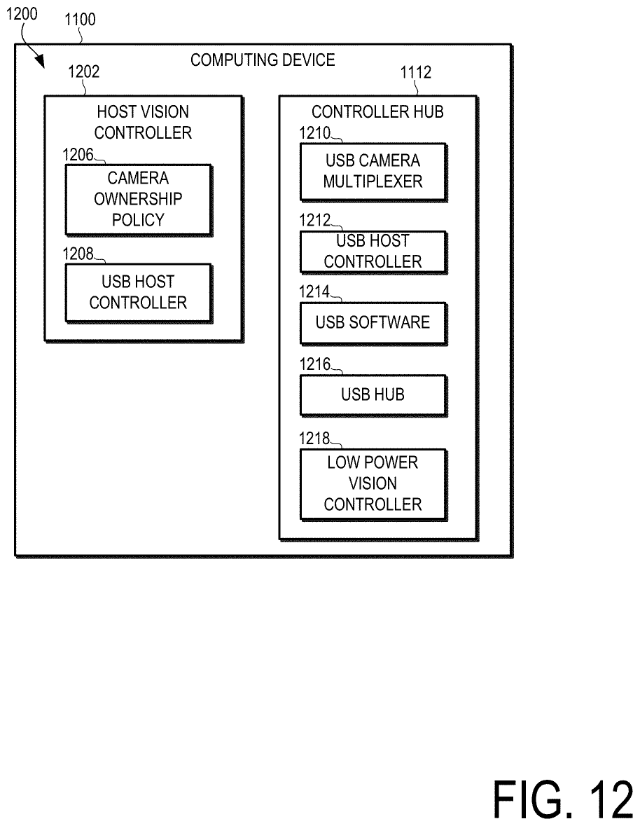

Referring now to FIG. 12, in an illustrative embodiment, the computing device 1100 establishes an environment 1200 during operation. The illustrative environment 1200 includes a host vision controller 1202 and a controller hub 1112. The various modules of the environment 1200 may be embodied as hardware, software, firmware, or a combination thereof. For example, the various modules, logic, and other components of the environment 1200 may form a portion of, or otherwise be established by, the processor 1102, the memory 1104, the data storage 1108, the display 1118, or other hardware components of the computing device 1100. As such, in some embodiments, one or more of the modules of the environment 1200 may be embodied as circuitry or collection of electrical devices (e.g., host vision controller circuitry 1202, controller hub circuitry 1112, etc.). It should be appreciated that, in such embodiments, one or more of the circuits (e.g., the host vision controller circuitry 1202, the controller hub circuitry 1112, etc.) may form a portion of one or more of the processor 1102, the memory 1104, the I/O subsystem 1106, the data storage 1108, the display 1118, an LCH (e.g., 155, 260, 305, 954), constituent components of an LCH (e.g., audio module 170, 264, 364; vision/imaging module 172, 263, 363) and/or other components of the computing device 1100. For example, in some embodiments, some or all of the modules may be embodied as the processor 1102 as well as the memory 1104 and/or data storage 1108 storing instructions to be executed by the processor 1102. Additionally, in some embodiments, one or more of the illustrative modules may form a portion of another module and/or one or more of the illustrative modules may be independent of one another. Further, in some embodiments, one or more of the modules of the environment 1200 may be embodied as virtualized hardware components or emulated architecture, which may be established and maintained by the processor 1102 or other components of the computing device 1100. It should be appreciated that some of the functionality of one or more of the modules of the environment 1200 may require a hardware implementation, in which case embodiments of modules that implement such functionality will be embodied at least partially as hardware.

The host vision controller 1202, which may be embodied as hardware, firmware, software, virtualized hardware, emulated architecture, and/or a combination thereof as discussed above, is configured to control the access to and use of vision data from the camera 1114 by some components of the computing device 1100, such as the processor 1102 and/or memory 1104. The host vision controller 1202 includes a camera ownership policy 1206 and a USB host controller 1208.

The camera ownership policy 1206 includes one or more rules or other policies for controlling ownership of the camera 1114. As described in more detail below, in one embodiment, the controller hub 1112 may access images from the camera for a low power vision controller 1218 for features such as Wake on Face described above. In such a case, if components of the computing device 1100 outside of the controller hub 1112 are not using images from the USB camera 1114, the camera ownership policy 1206 may indicate that the camera 1114 can be owned or controlled by the controller hub 1112. However, if other components of the computing device 1100 such as the processor 1102, the memory 1104, an application, etc., require access to images from the camera 1114, the camera ownership policy 1206 may indicate that the host vision controller 1202 can control the camera 1114. The host vision controller 1202 may send an instruction to the controller hub 1112 to hand ownership or control of the camera 1114 to the host vision controller 1202. The host vision controller 1202 may instruct the controller hub 1112 whether or not components of the controller hub 1112 can be allowed to access or process the images from the camera 1114 that are being sent to the host vision controller 1202.

The USB host controller 1208 is to act as the USB host for USB interactions with the controller hub 1112. The illustrative controller hub 1112 includes a device controller to interface with the USB host controller 1208, either directly or through a USB hub. The USB host controller 1208 can enumerate devices and/or hubs connected to it and can send and receive USB commands and data. The USB host controller 1208 and other USB-related devices described herein may use any suitable USB protocol, such as USB 1.0, USB 1.1, USB 2.0, USB 3.0, USB 3.1, USB 3.2, USB 4, etc.

The controller hub 1112 is to interface with one or more sensors such as the camera 1114 and may include one or more modules that process or otherwise act upon sensor data. The controller hub 1112 includes a USB camera multiplexer 1210, a USB host controller 1212, USB software 1214, a USB hub 1216, and a low power vision controller 1218.

The USB camera multiplexer 1210 has an input from the USB camera 1114 and two or more outputs. In the illustrative embodiment, the USB camera multiplexer 1210 has an output to the low power vision controller 1218 and an output to the USB hub 1216. Each output may include a complete set of USB data lines. The low power vision controller 1218 can control the output of the USB multiplexer 1210. In the illustrative embodiment, the low power vision controller 1218 can control the output of the camera 1114 to be sent from the USB multiplexer 1210 to the USB hub 1216, the low power vision controller 1218, or both. In the illustrative embodiment, when the output of the camera 1114 is sent to both the USB hub 1216 and the low power vision controller 1218, the USB hub 1216 (i.e., the USB host controller 1208 connected to the USB hub 1216) controls the camera 1114, and the low power vision controller 1218 snoops on the camera output. In the illustrative embodiment, data can flow both ways through the USB multiplexer 1210. In other words, for data flowing from the USB camera 1114 to the USB multiplexer 1210, the USB multiplexer 1210 acts as a 1:2 demultiplexer, and for data flowing from the USB host controller 1208 and USB host controller 1212, the USB multiplexer 1210 acts as a 2:1 multiplexer. As used herein, the “input” connection to the USB multiplexer 1210 refers to the connection to the USB device (e.g., the USB camera 1114), and the “output” connections to the USB multiplexer 1210 refer to the connections to the USB host (e.g., the USB host controller 1212 or USB hub 1216), even when the USB hub 1216 or USB host controller 1212 is sending data to the USB camera 1114 through the USB multiplexer 1210.

The USB host controller 1212 is configured to interface with the USB camera 1114. In some embodiments, the USB host controller 1212 may be able to perform a minimal set of functions deemed necessary to interface with the camera 1114.

The USB software 1214 is configured to control the camera 1114 through the USB host controller 1212. The USB software 1214 can configure the camera 1114, request images from the camera 1114, pass data from the camera 1114 to other components such as the low power vision controller 1218, etc.

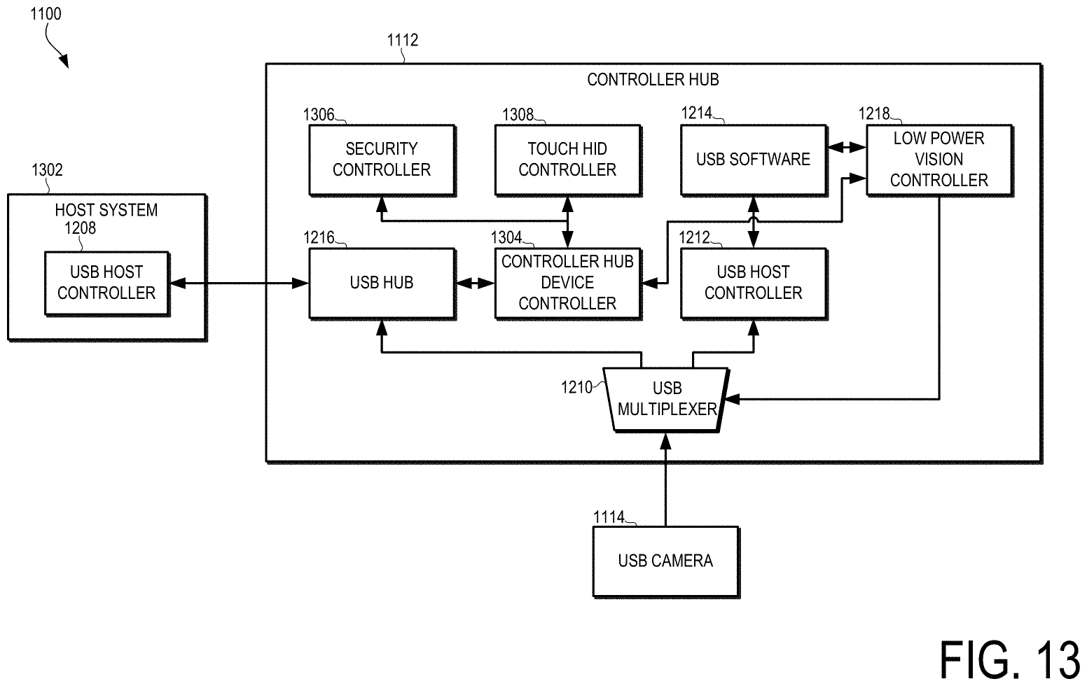

The USB hub 1216 is configured to interface with the USB host controller 1208 and one or more components that act as USB devices in the controller hub 1112. In the illustrative embodiment, the USB hub 1216 can interface with the camera 1114 and a controller hub device controller 1304 (see FIG. 13).

The low power vision controller 1218 is to process images from the camera 1114 and perform one or more tasks based on the images from the camera 1114. For example, the low power vision controller 1218 can perform functions such as the Wake on Face feature described above. As described above, the low power vision controller 1218 can also control the USB camera multiplexer 1210. When the low power vision controller 1218 has ownership of the USB camera 1114, the low power vision controller 1218 may specify a relatively low framerate for the USB camera 1114, such as 1-10 frames per second.

FIG. 13 is a simplified block diagram of one embodiment of communication paths between components of one embodiment of the computing device of FIG. 11 corresponding to the environment 1200. The host system 1302 includes the USB host controller 1208. The host system 1302 may include any suitable components of the computing device 1100 other than the controller hub 1112 and the USB camera 1114, such as the processor 1102, the memory 1104, etc. The USB host controller 1208 is connected to the USB hub 1216. A controller hub device controller 1304 is connected to the USB hub 1216. The controller hub device controller 1304 acts as the USB device controller, facilitating control of and interaction with various components of the controller hub 1112. The controller hub device controller 1304 may be connected to a security controller 1306, a touch human interface device (HID) controller 1308, and a low power vision controller 1218. The security controller 1306 may be responsible for loading and authenticating firmware stored in memory and executed by various components. The touch HID controller 1308 may be responsible for interfacing with a touchscreen sensor. The controller hub 1112 may include additional, fewer, or different modules than the ones shown in FIG. 13.

The USB multiplexer 1210 has an input from the USB camera 1114 and two outputs, one to the USB host controller 1212 and one to the USB hub 1216. The low power vision controller 1218 can control the USB multiplexer 1210.

The USB host controller 1212 is connected to USB software 1214, which is connected to the low power vision controller 1218. The USB host controller 1212 sends and receives messages from the camera 1114. The USB software 1214 controls the USB host controller 1212 and can receive images from the USB camera 1114 and forward it to the low power vision controller 1218.

It should be appreciated that the embodiment shown in FIG. 13 is merely one illustrative embodiment. In other embodiments, the computing device 1100 more include more, fewer, or different connections between various components than that shown in FIG. 13.

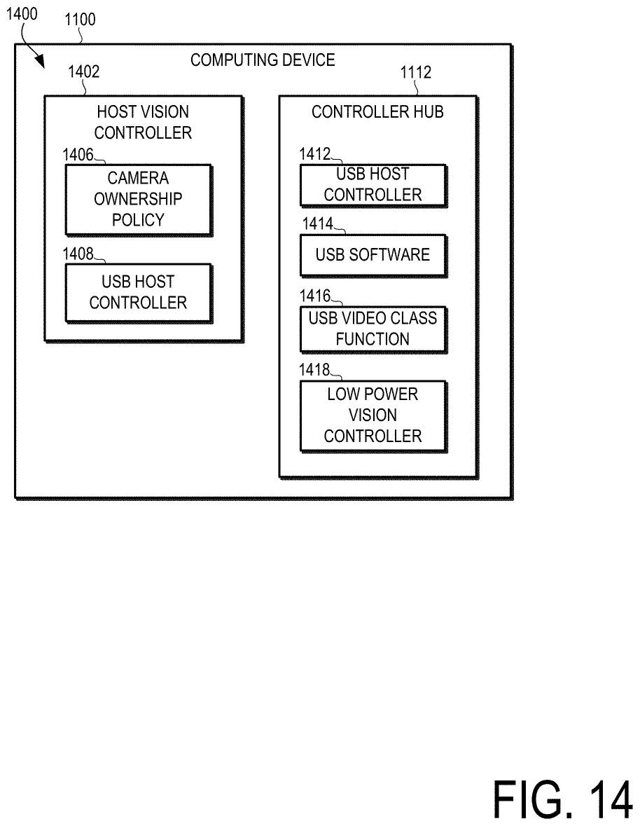

Referring now to FIG. 14, in an illustrative embodiment, the computing device 1100 establishes an environment 1400 during operation. The illustrative environment 1400 includes a host vision controller 1402 and a controller hub 1112. The various modules of the environment 1400 may be embodied as hardware, software, firmware, or a combination thereof. For example, the various modules, logic, and other components of the environment 1400 may form a portion of, or otherwise be established by, the processor 1102, the memory 1104, the data storage 1108, the display 1118, or other hardware components of the computing device 1100. As such, in some embodiments, one or more of the modules of the environment 1400 may be embodied as circuitry or collection of electrical devices (e.g., host vision controller circuitry 1402, controller hub circuitry 1112, etc.). It should be appreciated that, in such embodiments, one or more of the circuits (e.g., the host vision controller circuitry 1402, the controller hub circuitry 1112, etc.) may form a portion of one or more of the processor 1102, the memory 1104, the I/O subsystem 1106, the data storage 1108, the display 1118, an LCH (e.g., 155, 260, 305, 954), constituent components of an LCH (e.g., audio module 170, 264, 364; vision/imaging module 172, 263, 363) and/or other components of the computing device 1100. For example, in some embodiments, some or all of the modules may be embodied as the processor 1102 as well as the memory 1104 and/or data storage 1108 storing instructions to be executed by the processor 1102. Additionally, in some embodiments, one or more of the illustrative modules may form a portion of another module and/or one or more of the illustrative modules may be independent of one another. Further, in some embodiments, one or more of the modules of the environment 1400 may be embodied as virtualized hardware components or emulated architecture, which may be established and maintained by the processor 1102 or other components of the computing device 1100. It should be appreciated that some of the functionality of one or more of the modules of the environment 1400 may require a hardware implementation, in which case embodiments of modules that implement such functionality will be embodied at least partially as hardware.

The host vision controller 1402, which may be embodied as hardware, firmware, software, virtualized hardware, emulated architecture, and/or a combination thereof as discussed above, is configured to control the access to and use of vision data from the camera 1114 by some components of the computing device 1100, such as the processor 1102 and/or memory 1104. The host vision controller 1402 includes a camera ownership policy 1406 and a USB host controller 1408.

The camera ownership policy 1406 includes one or more rules or other policies for controlling ownership of the camera 1114. As described in more detail below, in one embodiment, the controller hub 1112 may access images from the camera for a low power vision controller 1418 for features such as Wake on Face described above. In such a case, if components of the computing device 1100 outside of the controller hub 1112 are not using images from the USB camera 1114, the camera ownership policy 1206 may indicate that the camera 1114 can be owned or controlled by the controller hub 1112. However, if other components of the computing device 1100 such as the processor 1102, the memory 1104, an application, etc., require access to images from the camera 1114, the camera ownership policy 1206 may indicate that the host vision controller 1402 can control the camera 1114. The host vision controller 1402 may send an instruction to the controller hub 1112 to hand ownership or control of the camera 1114 to the host vision controller 1202. The host vision controller 1402 may instruct the controller hub 1112 whether or not components of the controller hub 1112 can be allowed to access or process the images from the camera 1114 that are being sent to the host vision controller 1202.

The USB host controller 1408 is to act as the USB host for USB interactions with the controller hub 1112. The illustrative controller hub 1112 includes a device controller to interface with the USB host controller 1408, such as the controller hub device controller 1504. The controller hub device controller 1504 may be presented to the USB host controller 1408 as a composite USB device, as described in more detail below. The USB host controller 1208 can enumerate one or more classes of devices presented to it by the controller hub device controller 1504.

The controller hub 1112 is to interface with one or more sensors such as the camera 1114 and may include one or more modules that process or otherwise act upon sensor data. The controller hub 1112 includes a USB host controller 1412, USB software 1414, USB video class (UVC) function 1416, and a low power vision controller 1418.

The USB host controller 1412 is configured to interface with the USB camera 1114. In some embodiments, the USB host controller 1412 may be able to perform a minimal set of functions deemed necessary to interface with the camera 1114.

The USB software 1414 is configured to control the camera 1114 through the USB host controller 1412. The USB software 1414 can configure the camera 1114, request images from the camera 1114, pass data from the camera 1114 to other components such as the low power vision controller 1418 and UVC function 1416, etc. When the USB host controller 1412 is receiving images from the USB camera 1114, the USB software 1414 may also send the images to the low power vision controller 1418, possibly at a different frame rate. For example, in one embodiment, the USB software 1414 may send images from the USB camera 1114 to the low power vision controller 1418 at a rate of 1-10 frames per second and send images from the USB camera 1114 to the USB host controller 1412 (vis the UVC function 1416) at a rate of 24-60 frames per second.

The UVC function 1416 is configured to present as a USB camera device to the USB host controller 1412. The UVC function 1416 may pass along commands from the USB host controller 1412 to the camera 1114 and/or pass images from the camera 1114 to the USB host controller 1412.

The low power vision controller 1418 is to process images from the camera 1114 and perform one or more tasks based on the images from the camera 1114. For example, the low power vision controller 1418 can perform functions such as the Wake on Face feature described above. When the low power vision controller 1418 has ownership of the USB camera 1114, the low power vision controller 1418 may specify a relatively low framerate for the USB camera 1114, such as 1-10 frames per second.

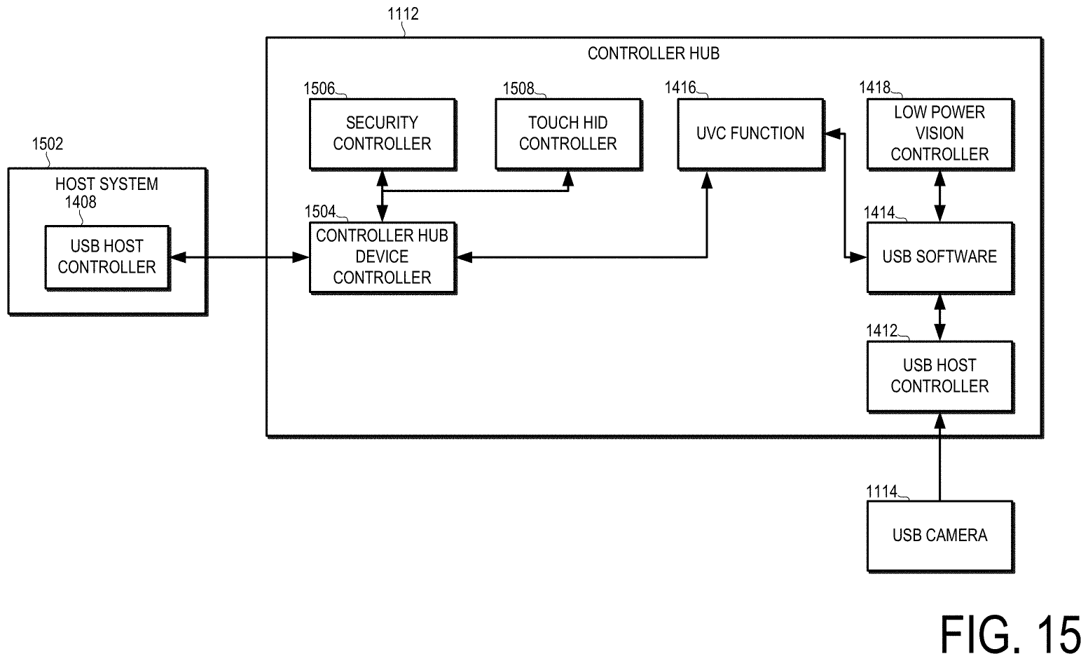

FIG. 15 is a simplified block diagram of one embodiment of communication paths between components of one embodiment of the computing device of FIG. 11 corresponding to the environment 1400. The host system 1502 includes the USB host controller 1408. The host system 1502 may include any suitable components of the computing device 1100 other than the controller hub 1112 and the USB camera 1114, such as the processor 1102, the memory 1104, etc. The USB host controller 1408 is connected to the controller hub device controller 1504. The controller hub device controller 1504 acts as the USB device controller, facilitating control of and interaction with various components of the controller hub 1112. The controller hub device controller 1504 is presented as a composite USB device, allowing for USB video class function as well as one or more other classes. The controller hub device controller 1504 may be connected to a security controller 1506 and a touch human interface device (HID) controller 1508, which may be similar to the corresponding components shown in FIG. 13. The controller hub device controller 1504 may also be connected to the UVC function 1416, allowing the USB host controller 1408 to interface with the UVC function 1416 and, through it, receive images from the USB camera 1114. The controller hub 1112 may include additional, fewer, or different modules than the ones shown in FIG. 15.

The USB host controller 1412 is connected to USB software 1414, which is connected to the low power vision controller 1418 and the UVC function 1416. The USB host controller 1412 sends and receives messages from the camera 1114. The USB software 1414 controls the USB host controller 1412 and can receive images from the USB camera 1114 and forward it to the low power vision controller 1418.

It should be appreciated that the embodiment shown in FIG. 15 is merely one illustrative embodiment. In other embodiments, the computing device 1100 more include more, fewer, or different connections between various components than that shown in FIG. 15.

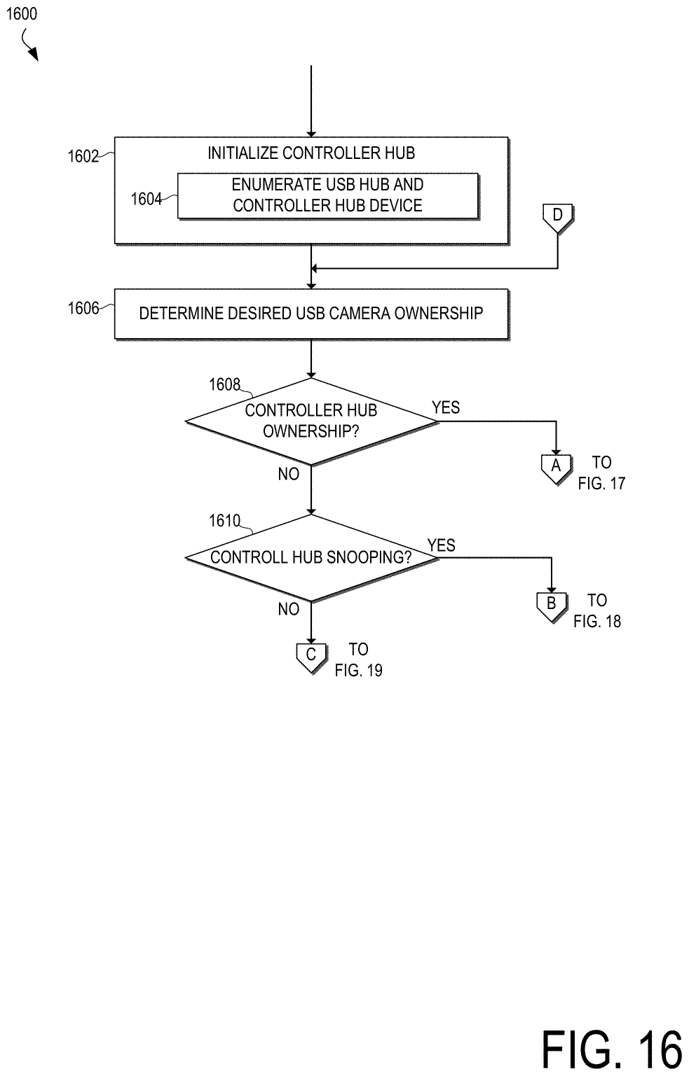

Referring now to FIG. 16, in use, the computing device 1100 may execute a method 1600 for accessing a USB camera 1114. The method 1600 begins in block 1602, in which the controller hub 1112 is initialized. In block 1604, the USB hub 1216 and controller hub device controller 1304 are enumerated by the USB host controller 1208. In the illustrative embodiment, the controller hub 1112 is initialized with the low power vision controller 1218 controlling the USB multiplexer 1210 to connect the camera 1114 to the USB host controller 1212.

In block 1606, the computing device 1100 determines a desired ownership of the USB camera 1114. The computing device 1100 may determine a desired ownership if the processor 1102 or application on the processor 1102 requires access to the camera 1114, in which case the USB host controller 1208 is the desired owner of the camera 1114. If no component outside of the controller hub 1112 requires access to the camera 1114, then the desired owner of the camera 1114 may be the low power vision controller 1218. If the USB host controller 1208 is to own the camera 1114, the computing device 1100 may also determine whether the low power vision controller 1218 is allowed to snoop on the images from the camera 1114.

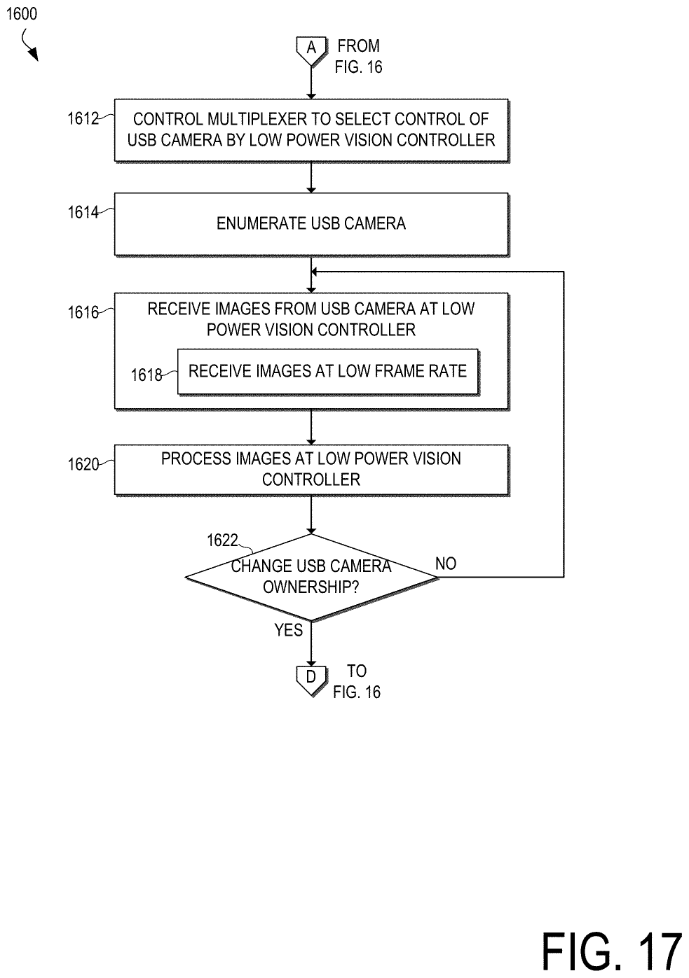

In block 1608, if the controller hub 1112 is to have ownership, the method jumps to block 1612 in FIG. 17. In block 1612, the low power vision controller 1218 controls the USB multiplexer 1210 to select control of the USB camera 1114 by the low power vision controller 1218.

In block 1614, in the illustrative embodiment, the USB host controller 1212 enumerates the USB camera 1114 whenever it is newly connected to the USB host controller 1212.

In block 1616, in the illustrative embodiment, the low power vision controller 1218 receives images from the USB camera 1114. In the illustrative embodiment, in block 1618, the low power vision controller 1218 receives images at a low frame rate, such as 1-10 frames per second.

In block 1620, the low power vision controller 1218 processes images. For example, the low power vision controller 1218 processes the images for a face in order to implement, e.g., the Wake on Face feature described above.

In block 1622, if ownership of the USB camera 1114 is not to change, the method 1600 loops back to block 1616. If ownership of the USB camera 1114 is to change, such as when the USB host controller 1208 sends a message instructing the controller hub 1112 to give it control of the USB camera 1114, the method loops back to block 1606 in FIG. 16.

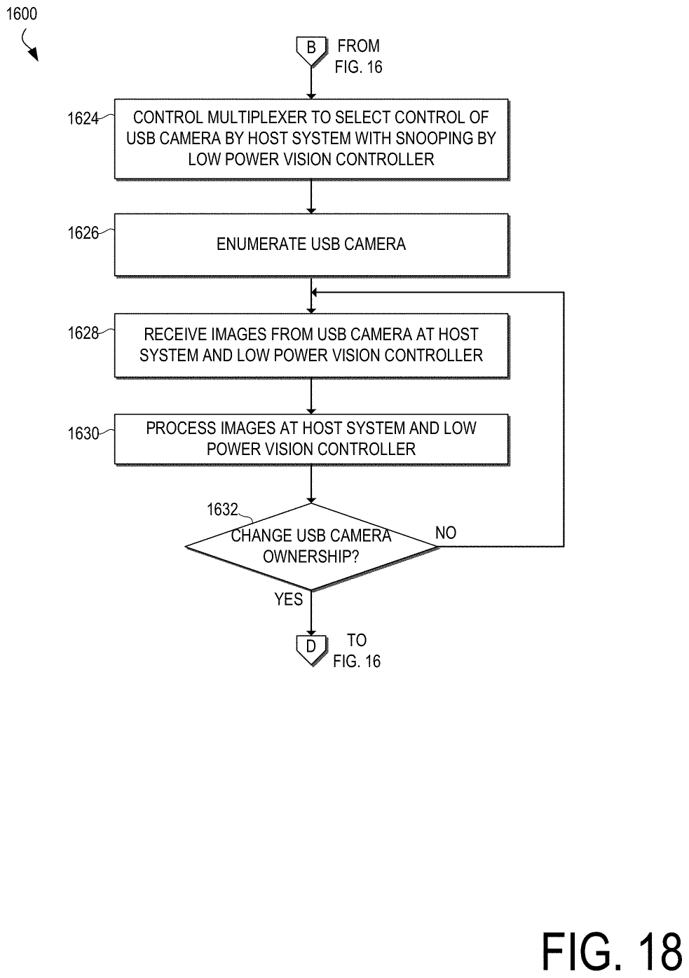

Referring back to block 1608, in FIG. 16, if the controller hub 1112 is not to control the USB camera 1114, the method proceeds to block 1610. In block 1610, if the controller hub 1112 is to snoop on the images from the USB camera 1114 sent to the USB host controller 1208, the method jumps to block 1624 in FIG. 18, in which the low power vision controller 1218 controls the USB multiplexer 1210 to select control of the USB camera 1114 by the USB host controller 1208, with images from the USB camera 1114 also sent to the USB host controller 1212 and the low power vision controller 1218.

In block 1626, in the illustrative embodiment, the USB host controller 1208 enumerates the USB camera 1114. As the low power vision controller 1218 is snooping on the data from the USB camera 1114 but not controlling it, the low power vision controller 1218 does not actively participate in the enumeration of the USB camera 1114.

In block 1628, in the illustrative embodiment, the USB host controller 1208 and the low power vision controller 1218 receives images from the USB camera 1114. In block 1630, the host system 1302 and the low power vision controller 1218 process images.

In block 1632, if ownership of the USB camera 1114 is not to change, the method 1600 loops back to block 1628. If ownership of the USB camera 1114 is to change, such as when the USB host controller 1208 sends a message instructing the controller hub 1112 relinquishing control of the USB camera 1114, the method loops back to block 1606 in FIG. 16.

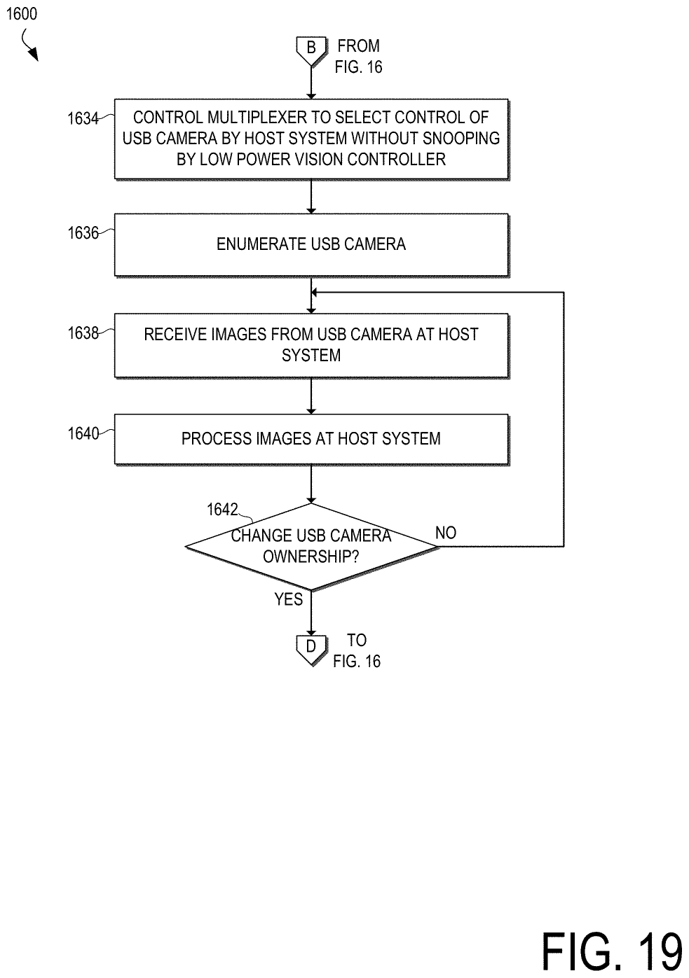

Referring back to block 1610, if the control hub 1112 is not to be allowed to snoop on the images from the USB camera 1114, the method 1600 proceeds to block 1634 in FIG. 19, in which the low power vision controller 1218 controls the USB multiplexer 1210 to select control of the USB camera 1114 by the USB host controller 1208, without allowing snooping of images from the USB camera 1114 by the low power vision controller 1218. In block 1636, in the illustrative embodiment, the USB host controller 1208 enumerates the USB camera 1114.

In block 1638, in the illustrative embodiment, the USB host controller 1208 receives images from the USB camera 1114. In block 1640, the host system 1302 processes images.

In block 1642, if ownership of the USB camera 1114 is not to change, the method 1600 loops back to block 1638. If ownership of the USB camera 1114 is to change, such as when the USB host controller 1208 sends a message instructing the controller hub 1112 relinquishing control of the USB camera 1114, the method loops back to block 1606 in FIG. 16.

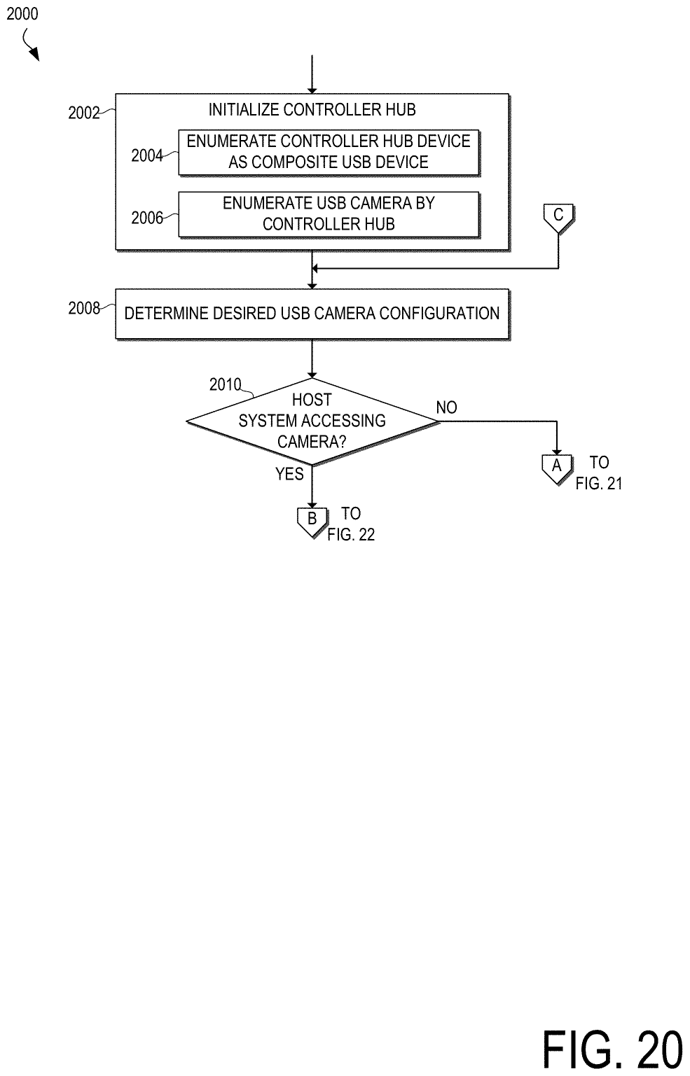

Referring now to FIG. 20, in use, the computing device 1100 may execute a method 2000 for accessing a USB camera 1114. The method 2000 begins in block 2002, in which the controller hub 1112 is initialized. In block 2004, the USB host controller 1208 enumerates the controller hub device controller 1504 as a composite USB device. The USB host controller 1412 of the controller hub 1112 enumerates the USB camera 1114 in block 2006. In the illustrative embodiment, the controller hub 1112 is initialized with the low power vision controller 1418 accessing the USB camera 1114 and with the UVC function 1416 not sending images to the USB host controller 1408.

In block 2008, the computing device 1100 determines a desired ownership of the USB camera 1114. The computing device 1100 may determine a desired ownership if the processor 1102 or application on the processor 1102 requires access to the camera 1114, in which case the USB host controller 1208 is the desired owner of the camera 1114. If no component outside of the controller hub 1112 requires access to the camera 1114, then the desired owner of the camera 1114 may be the low power vision controller 1418.

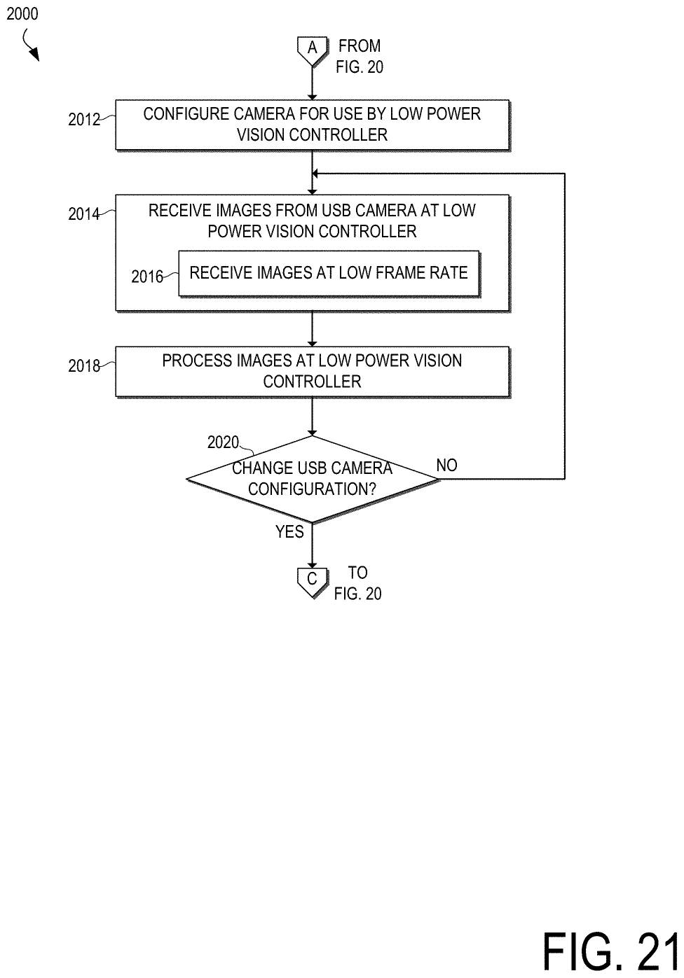

In block 2010, if the host system 1502 is not to access the camera 1114, the method jumps to block 2012 in FIG. 21. In block 2012, the USB camera 1114 is configured for use by the low power vision controller 1418. The format and/or frame rate of the USB camera 1114 may be configured. For example, the format may be a raw or other supported frame rate.

In block 2014, in the illustrative embodiment, the low power vision controller 1418 receives images from the USB camera 1114. In the illustrative embodiment, in block 2016, the low power vision controller 1418 receives images at a low frame rate, such as 1-10 frames per second.

In block 2018, the low power vision controller 1418 processes images. For example, the low power vision controller 1418 processes the images for a face in order to implement, e.g., the Wake on Face feature described above.

In block 2020, if configuration of the USB camera 1114 is not to change, the method 2000 loops back to block 2014. If configuration of the USB camera 1114 is to change, such as when the USB host controller 1208 sends a message instructing the controller hub 1112 to access images of the USB camera 1114, the method loops back to block 2008 in FIG. 20.

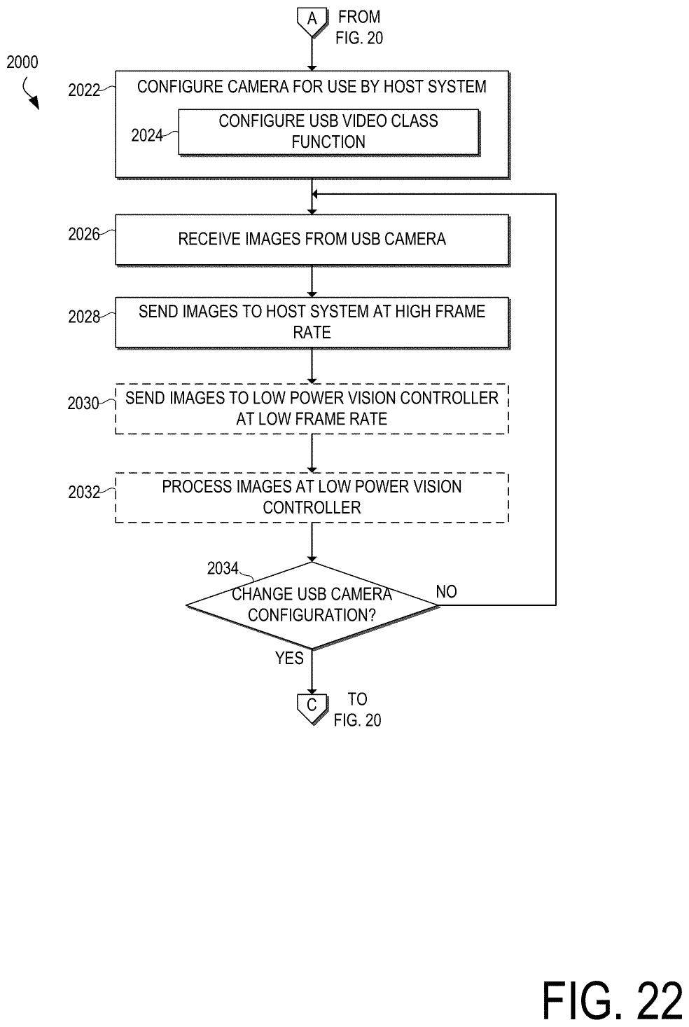

Referring back to block 2010, in FIG. 20, if the host system 1502 is to access the camera 1114, the method 2000 jumps to block 2022 in FIG. 22. In block 2022, the USB camera 1114 is configured for use by host system 1502. In block 2024, the USB video class (UVC) function 1416 is configured. The UVC function 1416 may configure the camera 1114 based on configuration parameters received from the USB host controller 1408. The format and/or frame rate of the USB camera 1114 may be configured. For example, the format may be a raw or other supported frame rate.

In block 2026, the USB software 1414 receives images from the USB camera 1114. The USB software 1414 may send the images to the UVC function 1416. In block 2028, the UVC function 1416 sends the images to the host system 1502 at a relatively high frame rate, such as 24-60 frames per second.

Optionally, in some embodiments, in block 2030, the USB software 1414 may send the images to the low power vision controller 1418 at a relatively low frame rate, such as 1-10 frames per second. In block 2032, the low power vision controller 1418 processes the images.

In block 2034, if configuration of the USB camera 1114 is not to change, the method 2000 loops back to block 2026. If configuration of the USB camera 1114 is to change, such as when the USB host controller 1208 sends a message instructing the controller hub 1112 to stop accessing images of the USB camera 1114, the method loops back to block 2008 in FIG. 20.

Although the embodiments described above use a USB protocol, it should be appreciated that the techniques described above can be applied to any suitable protocol. Additionally or alternatively, although the embodiments described above use a USB camera 1114, any other sensor such as a microphone may be used, in some embodiments.

### EXAMPLES

Illustrative examples of the technologies disclosed herein are provided below. An embodiment of the technologies may include any one or more, and any combination of, the examples described below.

Example 1 includes an apparatus comprising a controller hub comprising vision controller circuitry; a universal serial bus (USB) hub; and a USB multiplexer, wherein the USB multiplexer has one input and at least two outputs, wherein a first output of the USB multiplexer is connected to the USB hub and a second output of the USB multiplexer is connected to the vision controller circuitry.

Example 2 includes the subject matter of Example 1, and further including a USB camera connected to the one input of the USB multiplexer.

Example 3 includes the subject matter of any of Examples 1 and 2, and wherein the vision controller circuitry is to receive an instruction from USB host controller circuitry of a host system connected to the USB hub, wherein the instruction indicates that the USB host controller circuitry is to control the USB camera; and control, in response to the instruction, the USB multiplexer to provide the input from the USB camera to the first output.

Example 4 includes the subject matter of any of Examples 1-3, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 5 includes the subject matter of any of Examples 1-4, and wherein the second output of the USB multiplexer is connected to the vision controller circuitry through USB host controller circuitry of the controller hub.

Example 6 includes the subject matter of any of Examples 1-5, and wherein the USB hub is connected to a USB host controller circuitry of a host system, wherein a USB camera is connected to the one input of the USB multiplexer, wherein the USB host controller circuitry of the host system controls the USB camera through the USB multiplexer, wherein images from the USB camera are provided to the vision controller circuitry through the second output of the USB multiplexer while the USB host controller circuitry of the host system controls the USB camera.

Example 7 includes the subject matter of any of Examples I-6, and further including a base comprising a processor; and a lid connected to the base by one or more hinges, wherein the lid comprises a display, the controller hub, and a USB camera connected to the one input of the USB multiplexer.

Example 8 includes a method comprising determining, by a controller hub, a configuration of a universal serial bus (USB) multiplexer to be applied to the USB multiplexer, wherein the USB multiplexer has one input and at least two outputs, wherein a first output of the USB multiplexer is connected to a USB hub of the controller hub and a second output of the USB multiplexer is connected to vision controller circuitry of the controller hub; and controlling the USB multiplexer based on the determined configuration.

Example 9 includes the subject matter of Example 8, and wherein a USB camera is connected to the one input of the USB multiplexer.

Example 10 includes the subject matter of any of Examples 8 and 9, and further including receiving, by the vision controller circuitry, an instruction from USB host controller circuitry of a host system connected to the USB hub, wherein the instruction indicates that the USB host controller circuitry is to control the USB camera; and controlling, by the vision controller circuitry and in response to the instruction, the USB multiplexer to provide the input from the USB camera to the first output.

Example 11 includes the subject matter of any of Examples 8-10, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 12 includes the subject matter of any of Examples 8-11, and wherein the second output of the USB multiplexer is connected to the vision controller circuitry through USB host controller circuitry of the controller hub.

Example 13 includes the subject matter of any of Examples 8-12, and wherein the USB hub is connected to a USB host controller circuitry of a host system, wherein a USB camera is connected to the one input of the USB multiplexer, the method further comprising controlling, by the USB host controller circuitry of the host system, the USB camera through the USB multiplexer; and providing images from the USB camera to the vision controller circuitry through the second output of the USB multiplexer while the USB host controller circuitry of the host system controls the USB camera.

Example 14 includes an apparatus comprising means for determining, by a controller hub, a configuration of a universal serial bus (USB) multiplexer to be applied to the USB multiplexer, wherein the USB multiplexer has one input and at least two outputs, wherein a first output of the USB multiplexer is connected to a USB hub of the controller hub and a second output of the USB multiplexer is connected to vision controller circuitry of the controller hub; and means for controlling the USB multiplexer based on the determined configuration.

Example 15 includes the subject matter of Example 14, and wherein a USB camera is connected to the one input of the USB multiplexer.

Example 16 includes the subject matter of any of Examples 14 and 15, and further including means for receiving, by the vision controller circuitry, an instruction from USB host controller circuitry of a host system connected to the USB hub, wherein the instruction indicates that the USB host controller circuitry is to control the USB camera; and means for controlling, by the vision controller circuitry and in response to the instruction, the USB multiplexer to provide the input from the USB camera to the first output.

Example 17 includes the subject matter of any of Examples 14-16, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 18 includes the subject matter of any of Examples 14-17, and wherein the second output of the USB multiplexer is connected to the vision controller circuitry through USB host controller circuitry of the controller hub.

Example 19 includes the subject matter of any of Examples 14-18, and wherein the USB hub is connected to a USB host controller circuitry of a host system, wherein a USB camera is connected to the one input of the USB multiplexer, further comprising means for controlling, by the USB host controller circuitry of the host system, the USB camera through the USB multiplexer; and means for providing images from the USB camera to the vision controller circuitry through the second output of the USB multiplexer while the USB host controller circuitry of the host system controls the USB camera.

Example 20 includes an apparatus comprising a universal serial bus (USB) camera; a controller hub comprising USB host controller circuitry to interface with the USB camera; controller hub USB device controller circuitry to connect to a USB host controller circuitry of a host system; USB video class function circuitry to provide one or more images from the USB camera to the USB host controller circuitry of the host system; and vision controller circuitry to process the one or more images from the USB camera.

Example 21 includes the subject matter of Example 20, and wherein the controller hub is to receive an instruction from the USB host controller circuitry of the host system connected to the controller hub USB device controller circuitry, wherein the instruction indicates that the USB host controller circuitry is to control the USB camera; and provide, by the USB video class function circuitry, one or more commands from the USB host controller circuitry of the host system to the USB camera.

Example 22 includes the subject matter of any of Examples 20 and 21, and wherein the vision controller circuitry is to process raw images from the USB camera, wherein the USB video class function circuitry is to process the raw images from the USB camera before sending corresponding processed images to the USB host controller circuitry of the host system.

Example 23 includes the subject matter of any of Examples 20-22, and wherein the USB video class function circuitry is to provide the one or more images from the USB camera to the USB host controller circuitry of the host system at a first frame rate, wherein the vision controller circuitry is to receive the one or more images from the USB camera at a second frame rate, wherein the second frame rate is less than the first frame rate.

Example 24 includes the subject matter of any of Examples 20-23, and further including a base comprising a processor; and a lid connected to the base by one or more hinges, wherein the lid comprises a display, the controller hub, and the USB camera.

Example 25 includes a method comprising providing, by universal serial bus (USB) video class function circuitry of a controller hub, one or more images from a USB camera to USB host controller circuitry of a host system, wherein the USB host controller circuitry is connected to controller hub USB device controller circuitry of the controller hub; and processing, by vision controller circuitry of the controller hub, the one or more images from the USB camera.

Example 26 includes the subject matter of Example 25, and further including receiving, by the controller hub, an instruction from the USB host controller circuitry of the host system connected to the controller hub USB device controller circuitry, wherein the instruction indicates that the USB host controller circuitry is to control the USB camera; and providing, by the USB video class function circuitry, one or more commands from the USB host controller circuitry of the host system to the USB camera.

Example 27 includes the subject matter of any of Examples 25 and 26, and further including processing, by the vision controller circuitry, raw images from the USB camera; and processing, by USB video class function circuitry, the raw images from the USB camera before sending corresponding processed images to the USB host controller circuitry of the host system.

Example 28 includes the subject matter of any of Examples 25-27, and further including providing, by the USB video class function circuitry, the one or more images from the USB camera to the USB host controller circuitry of the host system at a first frame rate; and receiving, by the vision controller circuitry, the one or more images from the USB camera at a second frame rate, wherein the second frame rate is less than the first frame rate.

Example 29 includes an apparatus comprising means for providing, by universal serial bus (USB) video class function circuitry of a controller hub, one or more images from a USB camera to USB host controller circuitry of a host system, wherein the USB host controller circuitry is connected to controller hub USB device controller circuitry of the controller hub; and means for processing, by vision controller circuitry of the controller hub, the one or more images from the USB camera.

Example 30 includes the subject matter of Example 29, and further including means for receiving, by the controller hub, an instruction from the USB host controller circuitry of the host system connected to the controller hub USB device controller circuitry, wherein the instruction indicates that the USB host controller circuitry is to control the USB camera; and means for providing, by the USB video class function circuitry, one or more commands from the USB host controller circuitry of the host system to the USB camera.

Example 31 includes the subject matter of any of Examples 29 and 30, and further including means for processing, by the vision controller circuitry, raw images from the USB camera; and means for processing, by USB video class function circuitry, the raw images from the USB camera before sending corresponding processed images to the USB host controller circuitry of the host system.

Example 32 includes the subject matter of any of Examples 29-31, and further including means for providing, by the USB video class function circuitry, the one or more images from the USB camera to the USB host controller circuitry of the host system at a first frame rate; and means for receiving, by the vision controller circuitry, the one or more images from the USB camera at a second frame rate, wherein the second frame rate is less than the first frame rate.

Example 33 includes a computing device comprising a universal serial bus (USB) camera; a host system comprising USB host controller circuitry; a controller hub comprising vision controller circuitry; and USB host controller circuitry to interface with the USB camera, wherein the vision controller circuitry and the USB host controller circuitry of the host system are to receive one or more images generated by the USB camera contemporaneously.

Example 34 includes the subject matter of Example 33, and wherein the host system comprises a camera ownership policy, wherein the camera ownership policy comprises one or more rules indicating when the host system should control the USB camera.

Example 35 includes the subject matter of any of Examples 33 and 34, and wherein the controller hub further comprises a USB hub connected to the USB host controller circuitry of the host system; and a USB multiplexer, wherein the USB multiplexer has one input and at least two outputs, wherein a first output of the USB multiplexer is connected to the USB hub and a second output of the USB multiplexer is connected to the vision controller circuitry, wherein the USB camera is connected to the one input of the USB multiplexer.

Example 36 includes the subject matter of any of Examples 33-35, and wherein the vision controller circuitry is to receive an instruction from the USB host controller circuitry of the host system, wherein the instruction indicates that the USB host controller circuitry of the host system is to control the USB camera; and control, in response to the instruction, the USB multiplexer to provide input from the USB camera to the first output.

Example 37 includes the subject matter of any of Examples 33-36, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 38 includes the subject matter of any of Examples 33-37, and wherein the second output of the USB multiplexer is connected to the vision controller circuitry through the USB host controller circuitry of the controller hub.

Example 39 includes the subject matter of any of Examples 33-38, and wherein the USB host controller circuitry of the host system controls the USB camera through the USB multiplexer, wherein images from the USB camera are provided to the vision controller circuitry through the second output of the USB multiplexer while the USB host controller circuitry of the host system controls the USB camera.

Example 40 includes the subject matter of any of Examples 33-39, and further including a base comprising a processor; and a lid connected to the base by one or more hinges, wherein the lid comprises a display, the controller hub, and the USB camera.

Example 41 includes the subject matter of any of Examples 33-40, and wherein the controller hub further comprises controller hub USB device controller circuitry to connect to the USB host controller circuitry of the host system; and USB video class function circuitry to provide the one or more images from the USB camera to the USB host controller circuitry of the host system.

Example 42 includes the subject matter of any of Examples 33-41, and wherein the controller hub is to receive an instruction from the USB host controller circuitry of the host system connected to the controller hub USB device controller circuitry, wherein the instruction indicates that the USB host controller circuitry is to control the USB camera; and provide, by the USB video class function circuitry, one or more commands from the USB host controller circuitry of the host system to the USB camera.

Example 43 includes the subject matter of any of Examples 33-42, and wherein the vision controller circuitry is to process raw images from the USB camera, wherein the USB video class function circuitry is to process the raw images from the USB camera before sending corresponding processed images to the USB host controller circuitry of the host system.

Example 44 includes the subject matter of any of Examples 33-43, and wherein the USB video class function circuitry is to provide the one or more images from the USB camera to the USB host controller circuitry of the host system at a first frame rate, wherein the vision controller circuitry is to receive the one or more images from the USB camera at a second frame rate, wherein the second frame rate is less than the first frame rate.

Example 45 includes the subject matter of any of Examples 33-44, and further including a base comprising a processor; and a lid connected to the base by one or more hinges, wherein the lid comprises a display, the controller hub, and the USB camera.

Example 46 includes a method comprising receiving, by vision controller circuitry of a controller hub, one or more images generated by a universal serial bus (USB) camera; and receiving, by USB host controller circuitry of a host system, the one or more images generated by the USB camera contemporaneously with receiving of the one or more images by the vision controller circuitry, wherein the USB host controller circuitry is connected to the controller hub.

Example 47 includes the subject matter of Example 46, and further including determining, by the controller hub, a configuration of a universal serial bus (USB) multiplexer to be applied to the USB multiplexer, wherein the USB multiplexer has one input and at least two outputs, wherein a first output of the USB multiplexer is connected to a USB hub of the controller hub and a second output of the USB multiplexer is connected to the vision controller circuitry; and controlling the USB multiplexer based on the determined configuration.

Example 48 includes the subject matter of any of Examples 46 and 47, and

wherein a USB camera is connected to the one input of the USB multiplexer.

Example 49 includes the subject matter of any of Examples 46-48, and further including receiving, by the vision controller circuitry, an instruction from the USB host controller circuitry of the host system connected to the USB hub, wherein the instruction indicates that the USB host controller circuitry is to control the USB camera; and controlling, by the vision controller circuitry and in response to the instruction, the USB multiplexer to provide the input from the USB camera to the first output.

Example 50 includes the subject matter of any of Examples 46-49, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 51 includes the subject matter of any of Examples 46-50, and wherein the second output of the USB multiplexer is connected to the vision controller circuitry through USB host controller circuitry of the controller hub.

Example 52 includes the subject matter of any of Examples 46-51, and wherein the USB hub is connected to the USB host controller circuitry of the host system, wherein the USB camera is connected to the one input of the USB multiplexer, the method further comprising controlling, by the USB host controller circuitry of the host system, the USB camera through the USB multiplexer; and providing images from the USB camera to the vision controller circuitry through the second output of the USB multiplexer while the USB host controller circuitry of the host system controls the USB camera.

Example 53 includes the subject matter of any of Examples 46-52, and further including providing, by USB video class function circuitry of the controller hub, the one or more images from the USB camera to the USB host controller circuitry of the host system, wherein the USB host controller circuitry is connected to controller hub USB device controller circuitry of the controller hub; and processing, by the vision controller circuitry of the controller hub, the one or more images from the USB camera.

Example 54 includes the subject matter of any of Examples 46-53, and further including receiving, by the controller hub, an instruction from the USB host controller circuitry of the host system connected to the controller hub USB device controller circuitry, wherein the instruction indicates that the USB host controller circuitry is to control the USB camera; and providing, by the USB video class function circuitry, one or more commands from the USB host controller circuitry of the host system to the USB camera.

Example 55 includes the subject matter of any of Examples 46-54, and further including processing, by the vision controller circuitry, raw images from the USB camera; and processing, by USB video class function circuitry, the raw images from the USB camera before sending corresponding processed images to the USB host controller circuitry of the host system.

Example 56 includes the subject matter of any of Examples 46-55, and further including providing, by the USB video class function circuitry, the one or more images from the USB camera to the USB host controller circuitry of the host system at a first frame rate; and receiving, by the vision controller circuitry, the one or more images from the USB camera at a second frame rate, wherein the second frame rate is less than the first frame rate.

Example 57 includes a computing device comprising means for receiving, by vision controller circuitry of a controller hub, one or more images generated by a universal serial bus (USB) camera; and means for receiving, by USB host controller circuitry of a host system, the one or more images generated by the USB camera contemporaneously with receiving of the one or more images by the vision controller circuitry, wherein the USB host controller circuitry is connected to the controller hub.

Example 58 includes the subject matter of Example 57, and further including means for determining, by the controller hub, a configuration of a universal serial bus (USB) multiplexer to be applied to the USB multiplexer, wherein the USB multiplexer has one input and at least two outputs, wherein a first output of the USB multiplexer is connected to a USB hub of the controller hub and a second output of the USB multiplexer is connected to the vision controller circuitry; and means for controlling the USB multiplexer based on the determined configuration.

Example 59 includes the subject matter of any of Examples 57 and 58, and

wherein a USB camera is connected to the one input of the USB multiplexer.

Example 60 includes the subject matter of any of Examples 57-59, and further including means for receiving, by the vision controller circuitry, an instruction from the USB host controller circuitry of the host system connected to the USB hub, wherein the instruction indicates that the USB host controller circuitry is to control the USB camera; and means for controlling, by the vision controller circuitry and in response to the instruction, the USB multiplexer to provide the input from the USB camera to the first output.

Example 61 includes the subject matter of any of Examples 57-60, and wherein the vision controller circuitry is able to control the one output of the USB multiplexer to (1) provide the input to the USB multiplexer to only the first output, (2) provide the input to the USB multiplexer to only the second output, or (3) provide the input to the USB multiplexer to both the first output and the second output.

Example 62 includes the subject matter of any of Examples 57-61, and wherein the second output of the USB multiplexer is connected to the vision controller circuitry through USB host controller circuitry of the controller hub.

Example 63 includes the subject matter of any of Examples 57-62, and wherein the USB hub is connected to the USB host controller circuitry of the host system, wherein the USB camera is connected to the one input of the USB multiplexer, further comprising means for controlling, by the USB host controller circuitry of the host system, the USB camera through the USB multiplexer; and means for providing images from the USB camera to the vision controller circuitry through the second output of the USB multiplexer while the USB host controller circuitry of the host system controls the USB camera.

Example 64 includes the subject matter of any of Examples 57-63, and further including means for providing, by USB video class function circuitry of the controller hub, the one or more images from the USB camera to the USB host controller circuitry of the host system, wherein the USB host controller circuitry is connected to controller hub USB device controller circuitry of the controller hub; and means for processing, by the vision controller circuitry of the controller hub, the one or more images from the USB camera.

Example 65 includes the subject matter of any of Examples 57-64, and further including means for receiving, by the controller hub, an instruction from the USB host controller circuitry of the host system connected to the controller hub USB device controller circuitry, wherein the instruction indicates that the USB host controller circuitry is to control the USB camera; and means for providing, by the USB video class function circuitry, one or more commands from the USB host controller circuitry of the host system to the USB camera.

Example 66 includes the subject matter of any of Examples 57-65, and further including means for processing, by the vision controller circuitry, raw images from the USB camera; and means for processing, by USB video class function circuitry, the raw images from the USB camera before sending corresponding processed images to the USB host controller circuitry of the host system.

Example 67 includes the subject matter of any of Examples 57-66, and further including means for providing, by the USB video class function circuitry, the one or more images from the USB camera to the USB host controller circuitry of the host system at a first frame rate; and means for receiving, by the vision controller circuitry, the one or more images from the USB camera at a second frame rate, wherein the second frame rate is less than the first frame rate.

1. An apparatus comprising:
a controller hub comprising:
vision controller circuitry;
a universal serial bus (USB) hub; and
a USB multiplexer,
wherein the USB multiplexer has one input and at least two outputs, wherein a first output of the USB multiplexer is connected to the USB hub and a second output of the USB multiplexer is connected to the vision controller circuitry.

2. The apparatus of claim 1, further comprising a USB camera connected to the one input of the USB multiplexer.

3. The apparatus of claim 2, wherein the vision controller circuitry is to:
receive an instruction from USB host controller circuitry of a host system connected to the USB hub, wherein the instruction indicates that the USB host controller circuitry is to control the USB camera; and
control, in response to the instruction, the USB multiplexer to provide the input from the USB camera to the first output.

4. The apparatus of claim 1, wherein the vision controller circuitry is able to control the one output of the USB multiplexer to: (1) provide the input to the USB multiplexer to only the first output, (2) provide the input to the USB multiplexer to only the second output, or (3) provide the input to the USB multiplexer to both the first output and the second output.

5. The apparatus of claim 1, wherein the second output of the USB multiplexer is connected to the vision controller circuitry through USB host controller circuitry of the controller hub.

6. The apparatus of claim 1, wherein the USB hub is connected to a USB host controller circuitry of a host system, wherein a USB camera is connected to the one input of the USB multiplexer,
wherein the USB host controller circuitry of the host system controls the USB camera through the USB multiplexer,
wherein images from the USB camera are provided to the vision controller circuitry through the second output of the USB multiplexer while the USB host controller circuitry of the host system controls the USB camera.

7. The apparatus of claim 1, further comprising:
a base comprising a processor; and
a lid connected to the base by one or more hinges, wherein the lid comprises a display, the controller hub, and a USB camera connected to the one input of the USB multiplexer.

8. An apparatus comprising:
a universal serial bus (USB) camera;
a controller hub comprising:
USB host controller circuitry to interface with the USB camera;
controller hub USB device controller circuitry to connect to a USB host controller circuitry of a host system;
USB video class function circuitry to provide one or more images from the USB camera to the USB host controller circuitry of the host system; and
vision controller circuitry to process the one or more images from the USB camera.

9. The apparatus of claim 8, wherein the controller hub is to:
receive an instruction from the USB host controller circuitry of the host system connected to the controller hub USB device controller circuitry, wherein the instruction indicates that the USB host controller circuitry is to control the USB camera; and
provide, by the USB video class function circuitry, one or more commands from the USB host controller circuitry of the host system to the USB camera.

10. The apparatus of claim 8, wherein the vision controller circuitry is to process raw images from the USB camera,
wherein the USB video class function circuitry is to process the raw images from the USB camera before sending corresponding processed images to the USB host controller circuitry of the host system.

11. The apparatus of claim 8, wherein the USB video class function circuitry is to provide the one or more images from the USB camera to the USB host controller circuitry of the host system at a first frame rate, wherein the vision controller circuitry is to receive the one or more images from the USB camera at a second frame rate, wherein the second frame rate is less than the first frame rate.

12. The apparatus of claim 8, further comprising:
a base comprising a processor; and
a lid connected to the base by one or more hinges, wherein the lid comprises a display, the controller hub, and the USB camera.

13. A computing device comprising:
a universal serial bus (USB) camera;
a host system comprising USB host controller circuitry;
a controller hub comprising:
vision controller circuitry; and
USB host controller circuitry to interface with the USB camera,
wherein the vision controller circuitry and the USB host controller circuitry of the host system are to receive one or more images generated by the USB camera contemporaneously.

14. The computing device of claim 13, wherein the host system comprises a camera ownership policy, wherein the camera ownership policy comprises one or more rules indicating when the host system should control the USB camera.

15. The computing device of claim 13, wherein the controller hub further comprises:
a USB hub connected to the USB host controller circuitry of the host system; and
a USB multiplexer,
wherein the USB multiplexer has one input and at least two outputs, wherein a first output of the USB multiplexer is connected to the USB hub and a second output of the USB multiplexer is connected to the vision controller circuitry, wherein the USB camera is connected to the one input of the USB multiplexer.

16. The computing device of claim 15, wherein the vision controller circuitry is to:
receive an instruction from the USB host controller circuitry of the host system, wherein the instruction indicates that the USB host controller circuitry of the host system is to control the USB camera; and
control, in response to the instruction, the USB multiplexer to provide input from the USB camera to the first output.

17. The computing device of claim 15, wherein the vision controller circuitry is able to control the one output of the USB multiplexer to: (1) provide the input to the USB multiplexer to only the first output, (2) provide the input to the USB multiplexer to only the second output, or (3) provide the input to the USB multiplexer to both the first output and the second output.

18. The computing device of claim 15, wherein the second output of the USB multiplexer is connected to the vision controller circuitry through the USB host controller circuitry of the controller hub.

19. The computing device of claim 15,
wherein the USB host controller circuitry of the host system controls the USB camera through the USB multiplexer,
wherein images from the USB camera are provided to the vision controller circuitry through the second output of the USB multiplexer while the USB host controller circuitry of the host system controls the USB camera.

20. The computing device of claim 15, further comprising:
a base comprising a processor; and
a lid connected to the base by one or more hinges, wherein the lid comprises a display, the controller hub, and the USB camera.

21. The computing device of claim 13, wherein the controller hub further comprises:
controller hub USB device controller circuitry to connect to the USB host controller circuitry of the host system; and
USB video class function circuitry to provide the one or more images from the USB camera to the USB host controller circuitry of the host system.

22. The computing device of claim 21, wherein the controller hub is to:
receive an instruction from the USB host controller circuitry of the host system connected to the controller hub USB device controller circuitry, wherein the instruction indicates that the USB host controller circuitry is to control the USB camera; and
provide, by the USB video class function circuitry, one or more commands from the USB host controller circuitry of the host system to the USB camera.

23. The computing device of claim 21, wherein the vision controller circuitry is to process raw images from the USB camera,
wherein the USB video class function circuitry is to process the raw images from the USB camera before sending corresponding processed images to the USB host controller circuitry of the host system.

24. The computing device of claim 21, wherein the USB video class function circuitry is to provide the one or more images from the USB camera to the USB host controller circuitry of the host system at a first frame rate, wherein the vision controller circuitry is to receive the one or more images from the USB camera at a second frame rate, wherein the second frame rate is less than the first frame rate.

25. The computing device of claim 21, further comprising:
a base comprising a processor; and
a lid connected to the base by one or more hinges, wherein the lid comprises a display, the controller hub, and the USB camera.
